(19) United States
(12) Patent Application Publication
(10) Pub. No.: US 2024/0243281 A1
(43) Pub. Date: Jul. 18, 2024

(54) LITHIUM ION CATHODES AND CELLS SUITABLE FOR LARGE-FORMAT BATTERIES AND LARGE-FORMAT BATTERIES CONTAINING LITHIUM ION CATHODES

(71) Applicant: ADVANCED CELL ENGINEERING, INC., Stuart, FL (US)

(72) Inventors: John Kaufman, Palm City, FL (US); Karim Zaghib, Longueil (CA); Ayyakkannu Manivannan, Stuart, FL (US); Thomas Madden, Stuart, FL (US)

(21) Appl. No.: 18/561,711

(22) PCT Filed: Nov. 8, 2022
(86) PCT No.: PCT/US2022/049306

§ 371 Date: Nov. 16, 2023

Related U.S. Application Data
(60) Provisional application No. 63/277,083, filed on Nov. 8, 2021.
(60) Provisional application No. 63/277,084, filed on Nov. 8, 2021.
(60) Provisional application No. 63/310,979, filed on Feb. 16, 2022.
(60) Provisional application No. 63/340,353, filed on May 10, 2022.
(60) Provisional application No. 63/400,355, filed on Aug. 23, 2022.
(60) Provisional application No. 63/410,538, filed on Sep. 27, 2022.

(51) Int. Cl. H01M 4/58; H01M 4/02; H01M 4/36; H01M 10/0525; H01M 10/0568; H01M 10/0585

(52) U.S. Cl. CPC H01M 4/58; H01M 4/364; H01M 10/0568; H01M 10/0585; H01M 2004/027; H01M 2004/028; H01M 10/0525

(57) ABSTRACT

The present disclosure provides an uncycled lithium ion cathode including a lithium manganese iron phosphate (LMFP) cathode active material, a lithium manganese nickel iron phosphate (LMNFP) cathode active material, a lithium iron phosphate (LFP) cathode active material, a lithium iron cobalt phosphate (LFCP) cathode active material, a lithium iron manganese cobalt phosphate (LFMCP) cathode active material, or any combinations thereof, and a manganese iron phosphate (MFP) cathode active material, a manganese nickel iron phosphate (MNFP) cathode active material, an iron phosphate (FP) cathode active material, an iron cobalt phosphate (FCP) cathode active material, an iron cobalt manganese phosphate (FMCP) cathode active material, or any combinations thereof. The present disclosure further provides a lithium ion cell including such a cathode, a battery including such a cell, a battery pack including such a battery and a method of forming an electrode stack in such a battery.

### PRIORITY CLAIM

The present application claims priority to U.S. Provisional Patent Application No. 63/277,083, filed Nov. 8, 2021, titled “BIPOLAR LITHIUM ION CATHODES AND CELLS AND BATTERIES CONTAINING LITHIUM ION CATHODES”, U.S. Provisional Patent Application No. 63/400,355, filed Aug. 23, 2022, titled “BIPOLAR LITHIUM ION CATHODES AND CELLS AND BATTERIES CONTAINING LITHIUM ION CATHODES”, U.S. Provisional Patent Application No. 63/277,084, filed Nov. 8, 2021, titled “LITHIUM ION CATHODES AND CELLS SUITABLE FOR LARGE-FORMAT BATTERIES AND LARGE-FORMAT BATTERIES CONTAINING LITHIUM ION CATHODES”, U.S. Provisional Patent Application No. 63/410,538, filed Sep. 27, 2022, titled “LITHIUM ION CATHODES AND CELLS SUITABLE FOR LARGE-FORMAT BATTERIES AND LARGE-FORMAT BATTERIES CONTAINING LITHIUM ION CATHODES”, U.S. Provisional Patent Application No. 63/310,979, filed Feb. 16, 2022, titled “HIGH CAPACITY LITHIUM ION ANODES AND CELLS AND BATTERIES CONTAINING LITHIUM ION ANODES”, and U.S. Provisional Patent Application No. 63/340,353, filed May 10, 2022, titled “SLOT ELECTRODE STACK AND ELECTROCHEMICAL CELLS AND BATTERIES CONTAINING A SLOT ELECTRODE STACK”, each of which is incorporated by reference herein in its entirety.

### TECHNICAL FIELD

The present disclosure relates to lithium ion cathodes, cells, and batteries with lithium ion cathodes as well as methods of forming these materials, cathodes, cells, or batteries. The cathodes, cells, and batteries contain cathode active materials that are a lithium metal phosphate in which the metal is a combination of iron, manganese, nickel, or cobalt, and a metal phosphate in which the metal is iron or a combination of iron, manganese, nickel, or cobalt. These cathodes and cells may be suitable for use in large-format batteries and batteries containing them may be large-format batteries. These cathodes, cells, and batteries may also exhibit safe discharge energy densities and be operable over a wide temperature range.

### BACKGROUND

As lighter and smaller portable electronic devices with increasing functionality continue to be developed, there is a correspondingly increasing demand for smaller, lighter batteries with increased energy density to power the devices. Such batteries can be used in small electronics, such as portable notebooks and computers, digital and cellular phones, personal digital assistants, and portable gaming consoles, and in higher energy applications, such as hybrid and electric cars, grid storage, and military or defense applications. Lithium ion batteries have been developed to address some of these needs.

A major challenge in lithium ion battery development is the limitation on many conventional lithium ion batteries to a usable temperature range that is less than is commonly experienced by devices they power. In one well-known example, this causes smartphones to simply cease operating at temperatures that are too high or too low. In addition, although many conventional lithium ion batteries may remain operable near the ends of their usable temperature range, they experience gradual drop-off in capacity or other important properties beginning well before the end of their usable temperature range and may cease to function as expected. Electric vehicle users are very familiar with this phenomena, as most experience differences in vehicle range depending on the temperature.

Another well-known problem with lithium ion batteries is the tendency for some such batteries to catch fire. This has led to a wide array of regulations and prohibitions, such as the banning of lithium ion batteries from checked airplane luggage and complex rules regarding their presence in even carry-on luggage, that are often quite inconvenient for users. One advance in reducing flammability of lithium ion batteries was the development of lithium metal phosphate cathodes, which generally operate at lower voltages than lithium metal oxide cathodes, allowing the use of safer electrolytes in the batteries. However, many electrolytes usable with lithium metal phosphate cathodes remain somewhat flammable, and those that are less flammable tend to cause other problems with battery performance, such as reduction in rate capability (generally reflected in layman's terms as how much power the battery can deliver), capacity (generally reflected in layman's terms as how much of a charge the battery can hold or low long it lasts between charges, e.g. a smartphone battery that lasts 10 hours vs. a one that lasts 13 hours), and cycle life (generally reflected in layman's terms as how many times the battery can be charged and discharged before impractically low amounts of runtime are experienced). This makes these batteries impractical for many uses.

Even when they do not catch fire readily, the electrolytes of many lithium ion batteries are corrosive, toxic, or evolve toxic constituents when in contact with air or water. In cases of extreme battery failure, cobalt can be released from traditional lithium cobalt oxide or other cobalt-containing batteries. In addition to being toxic, cobalt also is a major driver for lithium ion battery cost and supply chain complications.

### SUMMARY

The present disclosure provides an uncycled lithium ion cathode comprising: i) a lithium manganese iron phosphate (LMFP) cathode active material, a lithium manganese nickel iron phosphate (LMNFP) cathode active material, a lithium iron cobalt phosphate (LFCP), a lithium iron manganese cobalt phosphate (LFMCP) cathode active material, a lithium iron phosphate (LFP) cathode active material, or any combinations thereof; and ii) a manganese iron phosphate (MFP) cathode active material, a manganese nickel iron phosphate (MNFP) cathode active material, an iron manganese cobalt phosphate (FMCP) cathode active material, an iron cobalt phosphate (FCP), an iron phosphate (FP) cathode active material, or any combinations thereof.

In more specific embodiments, which may be combined with one another and with other aspects of this specification:
the uncycled lithium ion cathode comprises: i) a LMFP cathode active material; and ii) a MFP cathode active material, a MNFP cathode active material, a FCP cathode active material, a FMCP cathode active material, an FP cathode active material, or any combinations thereof;
the uncycled lithium ion cathode comprises: i) a LMNFP cathode active material; and ii) a MFP cathode active material, a MNFP cathode active material, a FCP cathode active material, a FMCP cathode active material, an FP cathode active material, or any combinations thereof;
the uncycled lithium ion cathode comprises: i) a LFP cathode active material; and ii) a MFP cathode active material, a MNFP cathode active material, a FCP cathode active material, a FMCP cathode active material, an FP cathode active material, or any combinations thereof;
the uncycled lithium ion cathode comprises: i) a LFCP cathode active material; and ii) a MFP cathode active material, a MNFP cathode active material, an FP cathode active material, an FCP cathode active material, an FMCP cathode active material, or any combinations thereof;
the uncycled lithium ion cathode comprises: i) a LFMCP cathode active material; and ii) a MFP cathode active material, a MNFP cathode active material, an FP cathode active material, an FCP cathode active material, an FMCP cathode active material, or any combinations thereof;
the uncycled lithium ion cathode comprises a lithiated cathode active material or combination of lithiated cathode active materials and an unlithiated cathode active material or combination of unlithiated cathode active materials as set forth in Table 1;
the LMFP cathode active material has the general chemical formula LiMnₓFe₁₋ₓPO₄, wherein 0.01≤x≤0.95; more specifically 0.01≤x≤0.5;
the MFP cathode active material has the general chemical formula MnₓFe₁₋ₓPO₄, wherein 0.01≤x≤0.95; more specifically 0.01≤x≤0.5;
the LMNFP cathode active material has the general chemical formula LiMnₓNi_{y}Fe_{1-(x+y)}PO₄, wherein 0<x<1, 0<y<1 and x+y<1; more specifically 0<x≤0.05, 0<y≤0.3, and 0<x+y≤0.3, further more specifically the ratio of x:y is in a range between 5:1 and 1:5;
the MNFP cathode active material has the general chemical formula MnₓNi_{y}Fe_{1-(x+y)}PO₄, wherein 0<x<1, 0<y<1 and x+y<1, more specifically 0<x≤0.05, 0<y≤0.3, and 0<x+y≤0.3, further more specifically the ratio of x:y is in a range between 5:1 and 1:5;
the LFCP cathode active material has the general chemical formula LiFe₁₋ₓCoₓPO₄, in which 0<x<1;
the FCP cathode active material has the general chemical formula Fe₁₋ₓCoₓPO₄, in which 0<x<1;
the LFMCP cathode active material has the general chemical formula LiFe_{1-(x+y)}MnₓCo_{y}PO₄, in which 0<x<1, 0<y<1 and x+y<1; further more specifically the ratio of x:y is in a range between 5:1 and 1:5;
The FMCP cathode active material has the general chemical formula Fe_{1-(x+y)}MnₓCo_{y}PO₄, in which 0<x<1, 0<y<1 and x+y<1; further more specifically the ratio of x:y is in a range between 5:1 and 1:5;
the relative amounts of i) LMFP cathode active material, LMNFP cathode active material, LFP cathode active material, LFCP cathode active material, or LFMCP cathode active material, or any combinations thereof; and ii) MFP cathode active material, MNFP cathode active material, FP cathode active material, FCP cathode active material, or FMCP cathode active material or any combinations thereof, are such that, when the cathode is cycled in an electrochemical cell, the cell at its tenth cycle has a specific energy within 10% of the maximum theoretical specific energy of the cell;
at least one of the LFP, LMFP, LMNFP, LFCP, LFMCP, FP, MFP, LMNFP, FCP, or FMCP is coated with conductive carbon;
the uncycled lithium ion cathode further comprises a conductivity enhancer, a polymer binder, or both; or
when the cathode is cycled in an electrochemical cell, the cell at its tenth cycle has a specific capacity that is about 100 mAh/g or more when measured at 23° C. when discharged from 4.2 V.

The present disclosure further provides a lithium ion cell comprising: an uncycled lithium ion cathode as disclosed in the present specification and particularly according to any embodiment disclosed in the present summary; an anode comprising an anode active material; and an electrolyte.

In more specific embodiments, which may be combined with one another and with other aspects of this specification:
the anode active material comprises a material selected from: a graphite, natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, including a single-walled carbon nanotube, hard carbon, or hard carbon and amorphous silicon or silicon nanotubes, or any combinations thereof;
the anode comprises a first anode active material and a second anode active material, both individually comprising a material selected from: a graphite, natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, including a single-walled carbon nanotube, hard carbon, or hard carbon and amorphous silicon or silicon nanotubes, or any combinations thereof;
the anode is uncycled and does not contain lithium;
the anode comprises a lithium reservoir;
the electrolyte comprises an organic liquid and a lithium salt;
the electrolyte is a liquid or gel and the cell further comprises a separator between the cathode and the anode, more specifically, the separator is coated on one or both sides with a ceramic material;
the electrolyte is a solid or gel and the cell does not contain a separator between the cathode and the anode;
an added source of lithium is provided in the cell that is not contained within the cathode;
when the cell is cycled, the cell has a discharge energy density of 200 Wh/kg or more when discharged from 4.2V to 2.5V at C/3, more specifically, the discharge energy density varies by 10% or less during discharge at a temperature in the range between about −40° C. and about 85° C.
when the cell is cycled, the cell has a volumetric discharge energy density of 500 Wh/L or more when discharged from 4.2V to 2.5V at C/3, more specifically, the volumetric discharge energy density varies by 10% or less during discharge at a temperature in the range between about −40° C. and about 85° C.;
the cell has a cycle life of about 1000 cycles or more; or
when the cell is cycled, the cathode active material has a resulting tap density of about 1.2 g/cm³ or more.

The present disclosure further provides a battery comprising at least one lithium ion cell as disclosed in the present specification and particularly according to any embodiment disclosed in the present summary; and a casing.

In more specific embodiments, which may be combined with one another and with other aspects of this specification:
the battery is a cylindrical cell, a prismatic cell, or a pouch cell;
the battery comprises an electrode stacks having a slotted structure created by an accordion-shaped separator; or
the battery is a prismatic cell comprising an electrode stack with aluminum metal at a first cut edge of the electrode stack and copper metal at a second cut edge of the electrode stack.

The present disclosure further provides a battery pack comprising: at least one battery as disclosed in the present specification and particularly according to any embodiment disclosed in the present summary; a positive connector; a negative connector; and a housing.

In more specific embodiments, which may be combined with other aspects of this specification, the battery pack further comprises safety equipment, control equipment, or any combinations thereof.

The present disclosure further provides a method of forming an electrode stack in a battery as disclosed in the present specification and particularly according to any embodiment disclosed in the present summary, the method comprising: folding a cathode and an anode with a separator between them back and forth to form an electrode stack with a first end at which folds are located; cutting the electrode stack with a laser to remove both ends at which folds are located and to form a first cut edge and a second cut edge; placing aluminum metal at the first cut edge; and placing copper metal at the second cut edge.

### BRIEF DESCRIPTION OF THE DRAWINGS

The disclosure may be better understood through reference to the following figures, which are not to scale, which depict embodiments of the present disclosure, and in which:

FIG. 1a is a schematic cross-sectional diagram of a cell according to the present disclosure with a liquid or gel electrolyte;

FIG. 1b is a schematic cross-sectional diagram of a cell according to the present disclosure with a solid electrolyte;

FIG. 2 is a schematic, cut-away elevation view diagram of a cylindrical battery having a jelly-roll configuration and including an anode and a cathode from FIG. 1b;

FIG. 3a is a schematic, partially cross-sectional elevation view diagram of folded electrode layers that may be used in the prismatic cell battery including anode and a cathode from FIG. 1a or FIG. 1b; and

FIG. 3b is a schematic cross-sectional diagram of a folded electrode stack to be placed in the prismatic cell battery of FIG. 3a showing how materials are cut and then repaired with metals to avoid edge effects;

FIG. 4 is a schematic diagram of an electric vehicle battery including a battery module or pack including prismatic cell batteries of FIG. 3a.

### DETAILED DESCRIPTION

The present disclosure relates to lithium ion cathodes, cells, and batteries with lithium ion cathodes as well as methods of forming these materials, cathodes, cells, or batteries. The cathodes, cells, and batteries contain cathode active materials that are a lithium metal phosphate in which the metal is a combination of iron, manganese, or nickel and a metal phosphate in which the metal is iron or a combination of iron, manganese, or nickel. In some embodiments cobalt may also be added to the lithium metal phosphate or metal phosphate, for example, to increase voltage. However, in many embodiments the cathode active material does not contain. In contrast to toxic cobalt, iron, manganese, and nickel are generally non-toxic and, even if released by damage to a battery, are very unlikely to be taken up by the body in harmful amounts. In addition, these cathode active materials may help prevent thermal runaway and resulting battery or cell damage and fires.

Cathode active materials that contain manganese in may suffer decreases in performance or failure due to dissolution of manganese through the cell, particularly during use. Non-lithiated metal phosphate in cathode active materials and cathode of the present disclosure may act as a stabilizing and balancing factor that decreases or prevents manganese dissolution during use of a cell.

These cathodes and cells may be suitable for use in large-format batteries and batteries containing them may be large-format batteries.

These cathodes, cells, and batteries may also exhibit safe discharge energy densities and be operable over a wide temperature range. They may also be designed to function with safer electrolytes that are non-flammable or less flammable than those used with lithium metal oxide cathodes, or that are not corrosive or an irritant (or at least are less so).

The cells and batteries may also exhibit sufficient cycle life to be commercially useful, for example in small electronic devices, such as phones, portable gaming systems, smartwatches, and laptop computers, as well as in EVs and PEVs, or grid storage.

The present disclosure also provides methods of manufacturing these cathode active materials.

As used herein following terms are ascribed the following meanings:

Chemical abbreviations are employed as is typical in the art. For example, a lithium ion may be designated as Li⁺ and an electron may be designated as e⁻. Weight % may be abbreviated as “wt %.” The notation C/x indicates that a cell or battery is discharged at a rate to fully discharge the cell or battery to the selected lower voltage cut off in x hours.

A “cathode” (which may also be referred to as a “positive electrode”) is the electrode to which, during discharge of a lithium ion electrochemical cell, electrons flow and combine with lithium ion (typically in the context of a metal oxide insertion or de-insertion d the lithium ion). During charge of the electrochemical cell, electrons flow from the cathode and lithium ions are also released from the cathode.

A “cathode active material” is a chemical that undergoes electrochemical reaction in the cathode to exchange lithium ions and electrons with other components of the electrochemical cell.

A “bipolar cathode” is a cathode including two different layers that differ in their cathode active material compositions and, thus, also in their energy density and power density. In the simplest version of a bipolar cathode, a first layer contains a first cathode active material and the second layer contains a second cathode active material, which differs in chemical composition and at least one electrochemical property from the first cathode active material. “Bipolar cathode” does not denote a conventional bipolar battery stack configuration.

An “anode” (which may also be referred to as a “negative electrode”) is the electrode from which, during discharge of a lithium ion electrochemical cell, electrons flow and from which lithium ions are released. During charge of the electrochemical cell, electrons flow to the anode, where they combine with lithium ion, often to form lithium metal (Li).

An “anode active material” is a chemical that undergoes electrochemical reaction in the anode to exchange lithium ions and electrons with other components of the electrochemical cell, or upon which lithium metal may be plated or removed as lithium ions and electrons are separated and recombined by the electrochemical reaction.

A “current collector” is a component of the cathode or anode that exchanges electrons directly or indirectly with the active material to allow the electrochemical reaction to proceed.

An “electrolyte” is a substance that can exchange lithium ions with the cathode and anode. The present disclosure provides embodiments with liquid electrolytes, which are suitable for use with many gel electrolytes as well. The present disclosure further provides embodiments with solid electrolytes.

A “cell” or “electrochemical cell” is a basic physical unit in which a complete electrochemical reaction may occur if the cell is electrically connected to an external energy sink or energy source. An electrochemical cell includes a cathode, and anode, and an electrolyte. Unless the electrolyte forms an electrically non-conductive barrier between the anode and cathode, the electrochemical cell also contains a separator that forms an electrically non-conductive barrier between the anode and cathode. An electrochemical cell also includes a container that maintains the electrochemical cell as a physical unit, such as by containing a liquid or gel electrolyte, excluding air or water from the cell, or protecting the cell components from physical damage.

A “battery” is a more complex physical unit that includes at least one electrochemical cell combined with at least one other component not a part of the electrochemical cell, such as a housing or a second or more electrochemical cells. A battery may also include other components, such as vents, air circulation systems, fire suppression systems, electrical conductors, such as wiring or bars, identification components, and even a processor and associated memory, which may for example, assess battery status and control battery functions. Such an integrated assembly may also be referred to as a pack or module.

“Uncycled” refers to a cell or battery that has never been charged and discharged or to an anode or cathode or an anode active material or cathode active material that has never been charged and discharged in a cell or battery.

“Hard carbon” is a solid form of carbon that cannot be converted to graphite by heat-treatment at temperatures up to 3000° C. and may also be referred to as “non-graphitizing carbon” as a result. Hard carbon may be formed by heating a suitable carbon-based precursor to 1000° C. in the absence of oxygen.

Unless otherwise specified, the term “including” is used in the expansive sense and means “not limited to.” Likewise, “or” is used expansively and means both one of the listed options and combination of more than one of the listed options (i.e. and/or). “A” “an,” and “the” include more than one. “About,” as used herein, means within a variation of 1%.

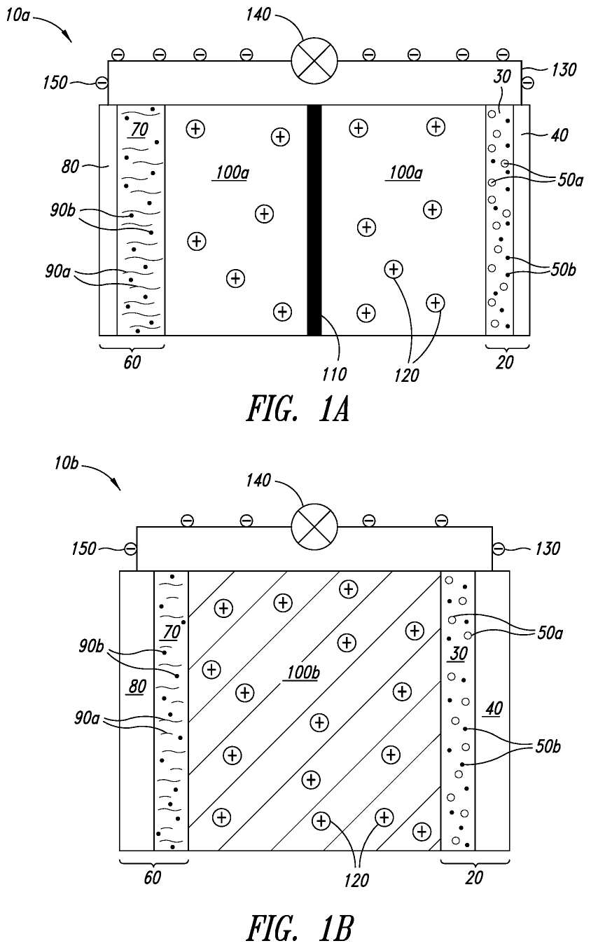

Numerical designations followed by a and b indicate similar components that may collectively be referred to by the numeral only. Specifically, a reference to “cell 10” or “electrochemical cell 10” should be interpreted as referring to either cell or electrochemical cell 10a, cell or electrochemical cell 10b, or both. A reference to “electrolyte 100” should be interpreted as referring to either liquid electrolyte 100a, solid electrolyte 100b, or both. In addition, references to “FIG. 1” should be interpreted as applicable to both FIG. 1a and FIG. 1b. A reference to “cathode active material 50” should be interpreted as referring to either lithium metal phosphate cathode active material 50a, metal phosphate cathode active material 50b, or both.

All lists items disclosed herein should be interpreted as including any combinations thereof unless otherwise specified.

All bounded and unbounded ranges recited herein should be interpreted as including both all values between the endpoint values (or above or below the endpoint value, as the case may be, for unbounded ranges) and the endpoint values. The terms “in a range from” and “between” both include endpoint values.

### Electrochemical Cells

Referring now to FIGS. 1-4, the present disclosure, according to some embodiments, provides an electrochemical cell 10 (shown in FIG. 1a as embodiment 10a with a liquid electrolyte 100a and in FIG. 1b as embodiment 10b with a solid electrolyte 100b), which may be in a battery, for example battery 200, battery 300, battery 400, or battery 500. The electrochemical cell 10 includes a cathode 20, and anode 60, and an electrolyte 100.

Cathode 20 includes a cathode layer 30 that contains cathode active material 50. Cathode 20 further includes cathode current collector 40.

Anode 60 includes anode layer 70 that contains anode active material 90. Anode 60 also includes anode current collector 80.

Electrolyte 100 contains lithium ions 120.

In the embodiment of FIG. 1a, electrolyte 100a is a liquid electrolyte and separator 110 electrically insulates cathode 20 from anode 60 within electrochemical cell 10a. Separator 100 allows at least lithium ions 120 to pass through it. This configuration may be used with gel electrolytes as well, particularly less viscous gel electrolytes.

In the embodiment of FIG. 1b, electrolyte 100b is a solid electrolyte. Typically, a solid electrolyte is chosen to be electrically insulative, such that as separator is not required, as depicted in the separator-less cell 10b of FIG. 1b. However, if needed a separator may be placed between two layers of solid electrolyte 100b, similar to the placement of separator 110 between two portions of liquid electrolyte 10a in FIG. 1a. This configuration may also be used with some gel electrolytes, particularly those that are sufficiently viscous or that otherwise have properties that avoid the passage of dendrites from the anode 60 to the cathode 20.

Electrochemical cell 10, when connected to electrically conductive external circuit 130, allows electrons 150 to pass through external circuit 130 from the anode to the cathode or vice versa.

In the example depicted in FIG. 1, electrochemical cell 10 is being discharged to power external load 140. If electrochemical cell 10 were being charged, an energy source, such as an DC power supply, would be in place of external load 140.

### Cathodes

The cathode active material 50, as found in an uncycled cathode 20, includes i) a lithium metal phosphate cathode active material 50a (a lithiated cathode active material) in which the metal is a combination of iron and at least one of manganese, nickel, and cobalt, and a metal phosphate cathode active material 50b (an unlithiated cathode active material) in which the metal is a combination of iron and at least one of manganese, nickel, and cobalt, or ii) more specifically, a lithium metal phosphate cathode active material 50a (a lithiated cathode active material) in which the metal is combination of iron and manganese and at least one of nickel and cobalt, and a metal phosphate cathode active material 50b (an unlithiated cathode active material) in which the metal is a combination of iron and manganese and at least one of nickel and cobalt. In some embodiments, the cathode active material 50 consists of these combinations.

In some embodiments, the lithiated cathode active material 50a is a LMFP cathode active material, a LMNFP cathode active material, a LFCP cathode active material, a LFMCP cathode active material, or a combination thereof, and the unlithiated cathode active material 50b is a MFP cathode active material, a MNFP cathode active material, a FCP cathode active material, a FMCP cathode active material, a FP cathode active material, or any combinations thereof. In some embodiments, the cathode active material 50 consists of these combinations.

In a more specific embodiment, the lithiated cathode active material 50a is a LMFP cathode active material and the unlithiated cathode active material 50b is a MFP cathode active material, a MNFP cathode active material, a FCP cathode active material, a FMCP cathode active material, a FP cathode active material, or any combinations thereof. In some embodiments, the cathode active material 50 consists of these combinations.

In another a more specific embodiment, the lithiated cathode active material 50a is a LMNFP cathode active material and the unlithiated cathode active material 50b is a MFP cathode active material, a MNFP cathode active material, a FCP cathode active material, a FMCP cathode active material, a FP cathode active material, or any combinations thereof. In some embodiments, the cathode active material 50 consists of these combinations. In some embodiments, the cathode active material 50 consists of these combinations.

In another more specific embodiment, the lithiated cathode active material 50a is a LFMCP cathode active material and the unlithiated cathode active material 50b is a MFP cathode active material, a MNFP cathode active material, a FCP cathode active material, a FMCP cathode active material, a FP cathode active material, or any combinations thereof.

In another more specific embodiment, the lithiated cathode active material 50a is a LFP cathode active material and the unlithiated cathode active material 50b is a MFP cathode active material, a MNFP cathode active material, a FCP cathode active material, a FMCP cathode active material, a FP cathode active material, or any combinations thereof. In some embodiments, the cathode active material 50 consists of these combinations.

In another specific embodiment, the lithiated cathode active material 50a is a LMFP cathode active material, a LMNFP cathode active material, a LFCP cathode active material, a LFMCP cathode active material, or a combination thereof, and the unlithiated cathode active material 50b is a MFP cathode active material. In some embodiments, the cathode active material 50 consists of these combinations.

In another specific embodiment, the lithiated cathode active material 50a is a LMFP cathode active material, a LMNFP cathode active material, a LFCP cathode active material, a LFMCP cathode active material, or a combination thereof, and the unlithiated cathode active material 50b is a MNFP cathode active material. In some embodiments, the cathode active material 50 consists of these combinations.

In another specific embodiment, the lithiated cathode active material 50a is a LMFP cathode active material, a LMNFP cathode active material, a LFCP cathode active material, a LFMCP cathode active material, or a combination thereof, and the unlithiated cathode active material 50b is a FP cathode active material. In some embodiments, the cathode active material 50 consists of these combinations.

In another specific embodiment, the lithiated cathode active material 50a is a LMFP cathode active material, a LMNFP cathode active material, a LFCP cathode active material, a LFMCP cathode active material, or a combination thereof, and the unlithiated cathode active material 50b is a FMCP cathode active material. In some embodiments, the cathode active material 50 consists of these combinations.

In a more specific embodiment, the lithiated cathode active material 50a is a LMFP cathode active material and the unlithiated cathode active material 50b is a MFP cathode active material. In some embodiments, the cathode active material 50 consists of these combinations.

In a more specific embodiment, the lithiated cathode active material 50a is a LMFP cathode active material and the unlithiated cathode active material 50b is an FP cathode active material. In some embodiments, the cathode active material 50 consists of these combinations.

In a more specific embodiment, the lithiated cathode active material 50a is a LMNFP cathode active material and the unlithiated cathode active material 50b is a MNFP cathode active material. In some embodiments, the cathode active material 50 consists of these combinations.

In a more specific embodiment, the lithiated cathode active material 50a is a LMNFP cathode active material and the unlithiated cathode active material 50b is a MFP cathode active material. In some embodiments, the cathode active material 50 consists of these combinations.

In a more specific embodiment, the lithiated cathode active material 50a is a LMNFP cathode active material and the unlithiated cathode active material 50b is an FP cathode active material. In some embodiments, the cathode active material 50 consists of these combinations.

In some embodiments, the uncycled cathode 20 includes a lithiated cathode active material or combination of lithiated cathode active materials 50a and an unlithiated cathode active material or combination of lithiated cathode active materials 50b as set forth in Table 1 (the combination of lithiated and unlithiated cathode active materials in the same embodiment appear in the same row of the table).

TABLE 1
Uncycled Cathode Material Combinations

| Lithiated Cathode | Unlithiated Cathode |
|---|---|
| Active Material(s) | Active Material(s) |
| LMFP | MFP/MNFP/FP/FCP/FMCP |
| LMFP | MFP/MNFP/FP/FMCP |
| LMFP | MFP/MNFP/FP/FCP |
| LMFP | MFP/MNFP/FP |
| LMFP | MFP/MNFP.FMCP/FCP |
| LMFP | MFP/MNFP/FMCP |
| LMFP | MFP/MNFP/FCP |
| LMFP | MFP/MNFP |
| LMFP | MFP/FP/FMCP/FCP |
| LMFP | MFP/FP/FMCP |
| LMFP | MFP/FP/FCP |
| LMFP | MFP/FP |
| LMFP | MNFP/FP/FMCP/FCP |
| LMFP | MNFP/FP/FMCP |
| LMFP | MNFP/FP/FCP |
| LMFP | MNFP/FP |
| LMFP | FMCP/MFP/FCP |
| LMFP | FMCP/MFP |
| LMFP | MFP/FCP |
| LMFP | MFP |
| LMFP | FMCP/MNFP/FCP |
| LMFP | FMCP/MNFP |
| LMFP | MNFP/FCP |
| LMFP | MNFP |
| LMFP | FMCP/FP |
| LMFP | FP/FCP |
| LMFP | FP |
| LMFP | FMCP/FCP |
| LMFP | FMCP |
| LMFP | FCP |
| LMNFP | MFP/MNFP/FP/FCP/FMCP |
| LMNFP | MFP/MNFP/FP/FMCP |
| LMNFP | MFP/MNFP/FP/FCP |
| LMNFP | MFP/MNFP/FP |
| LMNFP | MFP/MNFP.FMCP/FCP |
| LMNFP | MFP/MNFP/FMCP |
| LMNFP | MFP/MNFP/FCP |
| LMNFP | MFP/MNFP |
| LMNFP | MFP/FP/FMCP/FCP |
| LMNFP | MFP/FP/FMCP |
| LMNFP | MFP/FP/FCP |
| LMNFP | MFP/FP |
| LMNFP | MNFP/FP/FMCP/FCP |
| LMNFP | MNFP/FP/FMCP |
| LMNFP | MNFP/FP/FCP |
| LMNFP | MNFP/FP |
| LMNFP | FMCP/MFP/FCP |
| LMNFP | FMCP/MFP |
| LMNFP | MFP/FCP |
| LMNFP | MFP |
| LMNFP | FMCP/MNFP/FCP |
| LMNFP | FMCP/MNFP |
| LMNFP | MNFP/FCP |
| LMNFP | MNFP |
| LMNFP | FMCP/FP |
| LMNFP | FP/FCP |
| LMNFP | FP |
| LMNFP | FMCP/FCP |
| LMNFP | FMCP |
| LMNFP | FCP |
| LFP | MFP/MNFP/FP/FCP/FMCP |
| LFP | MFP/MNFP/FP/FMCP |
| LFP | MFP/MNFP/FP/FCP |
| LFP | MFP/MNFP/FP |
| LFP | MFP/MNFP.FMCP/FCP |
| LFP | MFP/MNFP/FMCP |
| LFP | MFP/MNFP/FCP |
| LFP | MFP/MNFP |
| LFP | MFP/FP/FMCP/FCP |
| LFP | MFP/FP/FMCP |
| LFP | MFP/FP/FCP |
| LFP | MFP/FP |
| LFP | MNFP/FP/FMCP/FCP |
| LFP | MNFP/FP/FMCP |
| LFP | MNFP/FP/FCP |
| LFP | MNFP/FP |
| LFP | FMCP/MFP/FCP |
| LFP | FMCP/MFP |
| LFP | MFP/FCP |
| LFP | MFP |
| LFP | FMCP/MNFP/FCP |
| LFP | FMCP/MNFP |
| LFP | MNFP/FCP |
| LFP | MNFP |
| LFP | FMCP/FP |
| LFP | FP/FCP |
| LFP | FP |
| LFP | FMCP/FCP |
| LFP | FMCP |
| LFP | FCP |
| LFCP | MFP/MNFP/FP/FCP/FMCP |
| LFCP | MFP/MNFP/FP/FMCP |
| LFCP | MFP/MNFP/FP/FCP |
| LFCP | MFP/MNFP/FP |
| LFCP | MFP/MNFP.FMCP/FCP |
| LFCP | MFP/MNFP/FMCP |
| LFCP | MFP/MNFP/FCP |
| LFCP | MFP/MNFP |
| LFCP | MFP/FP/FMCP/FCP |
| LFCP | MFP/FP/FMCP |
| LFCP | MFP/FP/FCP |
| LFCP | MFP/FP |
| LFCP | MNFP/FP/FMCP/FCP |
| LFCP | MNFP/FP/FMCP |
| LFCP | MNFP/FP/FCP |
| LFCP | MNFP/FP |
| LFCP | FMCP/MFP/FCP |
| LFCP | FMCP/MFP |
| LFCP | MFP/FCP |
| LFCP | MFP |
| LFCP | FMCP/MNFP/FCP |
| LFCP | FMCP/MNFP |
| LFCP | MNFP/FCP |
| LFCP | MNFP |
| LFCP | FMCP/FP |
| LFCP | FP/FCP |
| LFCP | FP |
| LFCP | FMCP/FCP |
| LFCP | FMCP |
| LFCP | FCP |
| LFMCP | MFP/MNFP/FP/FCP/FMCP |
| LFMCP | MFP/MNFP/FP/FMCP |
| LFMCP | MFP/MNFP/FP/FCP |
| LFMCP | MFP/MNFP/FP |
| LFMCP | MFP/MNFP.FMCP/FCP |
| LFMCP | MFP/MNFP/FMCP |
| LFMCP | MFP/MNFP/FCP |
| LFMCP | MFP/MNFP |
| LFMCP | MFP/FP/FMCP/FCP |
| LFMCP | MFP/FP/FMCP |
| LFMCP | MFP/FP/FCP |
| LFMCP | MFP/FP |
| LFMCP | MNFP/FP/FMCP/FCP |
| LFMCP | MNFP/FP/FMCP |
| LFMCP | MNFP/FP/FCP |
| LFMCP | MNFP/FP |
| LFMCP | FMCP/MFP/FCP |
| LFMCP | FMCP/MFP |
| LFMCP | MFP/FCP |
| LFMCP | MFP |
| LFMCP | FMCP/MNFP/FCP |
| LFMCP | FMCP/MNFP |
| LFMCP | MNFP/FCP |
| LFMCP | MNFP |
| LFMCP | FMCP/FP |
| LFMCP | FP/FCP |
| LFMCP | FP |
| LFMCP | FMCP/FCP |
| LFMCP | FMCP |
| LFMCP | FCP |

An uncycled cathode 20, i.e. when cathode 20 is formed and prior to any cycling of electrochemical cell 10, cathode layer 30 contains a mixture of lithium metal phosphate cathode active material 50a, which contains lithium ion, and of metal phosphate cathode active material 50b, which lacks lithium ion. This results in a cathode 50 in which a part of the cathode active material (the lithiated cathode active material 50a) is in a state corresponding to the dis-charged state of electrochemical cell 10, while part of the cathode active material (the unlithiated cathode active material 50b) is in a state corresponding to the charged state of electrochemical cell 10. The metals in lithiated cathode active material 50a are in a redox state and valence number corresponding to the dis-charged state of the battery, which is one less positive than the valence number corresponding to the charged state of the battery (e.g. Fe is Fe²⁺, not Fe³⁺). The metals in unlithiated cathode active material 50b are in a redox state and valence number corresponding to the charged state of the battery, which is one more positive than the valence number corresponding to the discharged state of the battery (e.g. Fe is Fe³⁺, not Fe²⁺).

During normal operation, the electrochemical cell 10 largely cycles at most only the number of lithium ions present in the lithium metal phosphate cathode active material 50a that is present when the cathode layer 30 is formed, prior to the initial cycling. So, although the relative proportions of lithiated forms of cathode active material 50 and unlithiated forms of cathode active material 50 may change as the cell 10 cycles, a substantial amount of unlithiated cathode active material 50 is present even when the cell 10 is fully discharged.

One potential source of failure in lithium ion cells and batteries is overcharge. Overcharge occurs when charging current continues to be forced through the cell or battery even after the maximum voltage or state of charge is reached. This causes more lithium ions to become deintercalated from the cathode. This extreme delithiation and associated high cathode potential can cause any number of problems, including damage to and breakdown of the internal crystal structure of the cathode active material, damage to and breakdown of the structure of cathode layer, including separation of the cathode active material from conductivity enhancers and binders or de-adherence of the cathode layer from the cathode current collector, and damage to the electrolyte, all of which may result in the production of gasses or physical expansion of solid materials that can cause the electrochemical cell or battery to bloat or even explode. These and other types of damage resulting from overcharge can also cause the cell or battery to begin to generate heat at a higher rate than the heat can dissipate to the external environment. When this happens, the situation is referred to as “thermal runaway” because heating is uncontrolled and may even cause further damage that lead to heating an increased rate. The end result of thermal runaway is often explosion or fire.

Even if one instance of overcharge does not result in damage to the cell or battery or thermal runaway, repeated overcharge does progressively more damage to the cell or battery, and makes eventual battery failure well before its intended cycle life or thermal runaway much more likely.

Cathodes 20 of the present disclosure, by virtue of normally containing some unlithiated cathode active material 50b even when cell 10 is fully discharged, limits the amount and extent to which Li can plate at the anode 60 while still operating at a higher potential due to maintaining built-in cathode state of charge that is greater than 0% when fully discharged. In some embodiments, the relative amount lithiated cathode active material 50a as compared to unlithiated cathode active material 50b may optimize the specific energy of cell 10 containing the cathode 20. For example, the relative amount of unlithiated cathode active material 50b may result in a specific energy within 10%, 5%, 2%, 1%, or 0.5% of the maximum actual or theoretical specific energy of cell 10 containing the cathode 20, particularly when combined with an anode 60 as disclosed herein. The relative amount of unlithiated cathode active material 50b may, more specifically, be such that that potential of cathode 20 is enhanced while having minimal effects on cell 10 capacity. In some embodiments, the wt % of unlithiated cathode active material(s) 50b as compared to the total weight of cathode active materials (50a+50b) may be in a range from 1 to 99, 5 to 95, 1 to 75, 5 to 75, 1 to 50, 5 to 50, 1 to 25, 5 to 25, 25 to 75, 25 to 50, or 50 to 75. In a more specific embodiment, the wt % of unlithiated cathode active material(s) 50b as compared to the total weight of cathode active materials (50a+50b) may be 50 or less, less than 50, in a range from 1 to 50, 1 to less than 50, 2 to 50, 2 to less than 50, 2 to 40, 1 to 40, 2 to 30, 1 to 30, 2 to 20, 1 to 20, 5 to less than 50, or 5 to 20.

Lithium metal phosphate cathode active materials 50a may include LMFP. In some embodiments, these materials have the general chemical formula LiMnₓFe₁₋ₓPO₄, wherein 0.01≤x≤0.95.

In more specific embodiments, 0.01≤x≤0.5, 0.01≤x≤0.4, 0.01≤x≤0.3, 0.01≤x≤0.25, 0.01≤x≤0.2, 0.01≤x≤0.15, 0.01≤x≤0.10, 0.01≤x≤0.05, 0.05≤x≤0.95, 0.05≤x≤0.5, 0.05≤x≤0.4, 0.05≤x≤0.3, 0.05≤x≤0.25, 0.05≤x≤0.2, 0.05≤x≤0.15, 0.05≤x≤0.1, 0.1≤x≤0.95, 0.1≤x≤0.5, 0.1≤x≤0.4, 0.1≤x≤0.3, 0.1≤x≤0.25, 0.1≤x≤0.2, 0.1≤x≤0.15, 0.15≤x≤0.95, 0.15≤x≤0.5, 0.15≤x≤0.4, 0.15≤x≤0.3, 0.15≤x≤0.25, 0.15≤x≤0.2, 0.2≤x≤0.95, 0.2≤x≤0.5, 0.2≤x≤0.4, 0.2≤x≤0.3, or 0.2≤x≤0.25. In a more specific embodiment, the materials have the chemical formula LiMn_{0.2}Fe_{0.8}PO₄.

In other more specific embodiments, 0.5≤x≤0.95, 0.5≤x≤0.8, 0.5≤x≤0.7, 0.5≤x≤0.6, 0.6≤x≤0.95, 0.6≤x≤0.8, 0.6≤x≤0.7, 0.7≤x≤0.95, 0.7≤x≤0.8, or 0.8≤x≤0.95. In a more specific embodiment, the materials have the chemical formula LiMn_{0.5}Fe_{0.5}PO₄, and LiMn_{0.8}Fe_{0.2} PO₄.

Lithium metal phosphate cathode active materials 50a may include LMNFP. In some embodiments, these materials have the general chemical formula LiMnₓNi_{y}Fe_{1-(x+y)}PO₄, in which 0<x<1, 0<y<1 and x+y<1. In some specific embodiments:
a) 0≤x≤0.05, more particularly 0.005≤x≤0.05, 0.005≤x≤0.04, 0.005≤x≤0.03, 0.005≤x≤0.02, 0.01≤x≤0.05, 0.01≤x≤0.04, 0.01≤x≤0.03, 0.01≤x≤0.02, 0.02≤x≤0.05, 0.02≤x≤0.04, 0.02≤x≤0.03, 0.03≤x≤0.05, 03, 0.03≤x≤0.04, or 0.04≤x≤0.05;
b) 0<y≤0.3, more particularly 0.005≤y≤0.3, 0.005≤y≤0.25, 0.005≤y≤0.2, 0.005≤y≤0.16, 0.005≤y≤0.15, 0.005≤y≤0.1, 0.005≤y≤0.05, 0.005≤y≤0.01, 0.01≤y≤0.3, 0.01≤y≤0.25, 0.01≤y≤0.2, 0.01≤y≤0.16, 0.01≤y≤0.15, 0.01≤y≤0.1, 0.01≤y≤0.05, 0.05≤y≤0.3, 0.05≤y≤0.25, 0.05≤y≤0.2, 0.05≤y≤0.16, 0.05≤y≤0.15, 0.05≤y≤0.1, 0.1≤y≤0.3, 0.1≤y≤0.25, 0.1≤y≤0.2, 0.1≤y≤0.16, 0.1≤y≤0.15, 0.15≤y≤0.3, 0.15≤y≤0.25, 0.15≤y≤0.2, 0.15≤y≤0.16, 0.16≤y≤0.3, 0.16≤y≤0.25, 0.16≤y≤0.2, 0.2≤y≤0.3, 0.2≤y≤0.25, or 0.25≤y≤0.3; or
c) 0<x+y≤0.3, more particularly 0.005<x+y≤0.3, 0.005<x+y≤0.25, 0.005<x+y≤0.2, 0.005≤x+y≤0.15, 0.005≤x+y≤0.1, 0.005≤x+y≤0.05, 0.005≤x+y≤0.01, 0.01≤x+y≤0.3, 0.01≤x+y≤0.25, 0.01≤x+y≤0.2, 0.01≤x+y≤0.15, 0.01≤x+y≤0.1, 0.01≤x+y≤0.05, 0.05≤x+y≤0.3, 0.05≤x+y≤0.25, 0.05≤x+y≤0.2, 0.05≤x+y≤0.15, 0.05≤x+y≤0.1, 0.1≤x+y≤0.3, 0.1≤x+y≤0.25, 0.1≤x+y≤0.2, 0.1≤x+y≤0.15, 0.15≤x+y≤0.3, 0.15≤x+y≤0.25, 0.15≤x+y≤0.2, 0.2≤x+y≤0.3, 0.2≤x+y≤0.25, or 0.25≤x+y≤0.3.

In any embodiments, particularly those of a), b), or c) the ratio of x:y may be in a range between 5:1 and 1:5, more particularly between 5:1 and 1:3, 5:1 and 1:1, 5:1 and 3:1, 3:1 and 1:5, 3:1 and 1:3, 3:1 and 1:1, 1:1 and 1:5, 1:1 and 1:3, 1:3 and 1:5.

In more specific embodiments, the ratio of x:y may be in a range between 1:2 and 1:5, more particularly between 1:2 and 1:4, 1:2 and 1:3, 1:3 and 1:5, 1:3 and 1:4, or 1:4 and 1:5.

In other more specific embodiments, the ratio of x:y may be in a range between 5:1 and 1:2, more particularly between 5:1 and 1:1, 4:1 and 1:2, 4:1 and 1:1, 3:1 and 1:2, 3:1 and 1:1, 2:1 and 1:2, and 2:1 and 1:1.

In a more specific embodiment, the materials have the chemical formula LiMn_{0.04}Ni_{0.16}Fe_{0.8}PO₄.

Lithium metal phosphate cathode active materials 50a may include LFCP. In some embodiments, LFCP has the general chemical formula LiFe₁₋ₓCoₓPO₄, in which 0<x<1. In some specific embodiments, x≥0.05, x≥0.1, x≥0.2, x≥0.3, x≥0.4, x≥0.5, x≥0.6, x≥0.7, x≥0.8, x≥0.9, or x≥0.95.

In some embodiments, LFMCP has the general chemical formula LiFe_{1-(x+y)}MnₓCo_{y}PO₄, in which 0<x<1, 0<y<1 and x+y<1. In some specific embodiments, a) 0<x≤0.5, more particularly 0.05≤x≤0.50, 0.05≤x≤0.25, 0.05≤x≤0.2, 0.05≤x≤0.15, 0.05≤x≤0.1, 0.1≤x≤0.5, 0.1≤x≤0.25, 0.1≤x≤0.2, or 0.1≤x≤0.15; b) 0≤y≤0.95, more particularly 0.05≤y≤0.95, 0.05≤y≤0.9, 0.05≤y≤0.75, 0.05≤y≤0.5, 0.05≤y≤0.25, 0.05≤y≤0.1, 0.1≤y≤0.95, 0.1≤y≤0.9, 0.1≤y≤0.75, 0.1≤y≤0.5, or 0.1≤y≤0.25; or c) 0≤x+y≤0.95, more particularly 0.05≤x+y≤0.95, 0.05≤x+y≤0.75, 0.05≤x+y≤0.5, 0.05≤x+y≤0.25, 0.05≤x+y≤0.1, 0.1≤x+y≤0.95, 0.1≤x+y≤0.9, 0.1≤x+y≤0.75, 0.1≤x+y≤0.5, or 0.1≤x+y≤0.25.

In any embodiments, particularly those of a), b), or c) the ratio of x:y may be in a range between 5:1 and 1:5, more particularly between 5:1 and 1:3, 5:1 and 1:1, 5:1 and 3:1, 3:1 and 1:5, 3:1 and 1:3, 3:1 and 1:1, 1:1 and 1:5, 1:1 and 1:3, 1:3 and 1:5.

In more specific embodiments, the ratio of x:y may be in a range between 1:2 and 1:5, more particularly between 1:2 and 1:4, 1:2 and 1:3, 1:3 and 1:5, 1:3 and 1:4, or 1:4 and 1:5.

In other more specific embodiments, the ratio of x:y may be in a range between 5:1 and 1:2, more particularly between 5:1 and 1:1, 4:1 and 1:2, 4:1 and 1:1, 3:1 and 1:2, 3:1 and 1:1, 2:1 and 1:2, and 2:1 and 1:1.

Lithium metal phosphate cathode active materials 50a may include LFP. In some embodiments, LFP has the general chemical formula LiFePO₄.

Metal phosphate cathode active materials 50b may include MFP. In some embodiments, MFP may have the general chemical formula MnₓFe₁₋ₓPO₄, wherein 0.01≤x≤0.95. In more specific embodiments, 0.01≤x≤0.5, 0.01≤x≤0.4, 0.01≤x≤0.3, 0.01≤x≤0.25, 0.01≤x≤0.2, 0.01≤x≤0.15, 0.01≤x≤0.10, 0.01≤x≤0.05, 0.05≤x≤0.95, 0.05≤x≤0.5, 0.05≤x≤0.4, 0.05≤x≤0.3, 0.05≤x≤0.25, 0.05≤x≤0.2, 0.05≤x≤0.15, 0.05≤x≤0.1, 0.1≤x≤0.95, 0.1≤x≤0.5, 0.1≤x≤0.4, 0.1≤x≤0.3, 0.1≤x≤0.25, 0.1≤x≤0.2, 0.1≤x≤0.15, 0.15≤x≤0.95, 0.15≤x≤0.5, 0.15≤x≤0.4, 0.15≤x≤0.3, 0.15≤x≤0.25, 0.15≤x≤0.2, 0.2≤x≤0.95, 0.2≤x≤0.5, 0.2≤x≤0.4, 0.2≤x≤0.3, or 0.2≤x≤0.25. In a more specific embodiment, the materials have the chemical formula Mn_{0.2}Fe_{0.8}PO₄.

In other more specific embodiments, 0.5≤x≤0.95, 0.5≤x≤0.8, 0.5≤x≤0.7, 0.5≤x≤0.6, 0.6≤x≤0.95, 0.6≤x≤0.8, 0.6≤x≤0.7, 0.7≤x≤0.95, 0.7≤x≤0.8, or 0.8≤x≤0.95. In a more specific embodiment, the materials have the chemical formula Mn_{0.5}Fe_{0.5}PO₄, and Mn_{0.8}Fe_{0.2} PO₄.

Metal phosphate cathode active materials 50b may include MNFP. In some embodiments, MNFP may have the general chemical formula MnₓNi_{y}Fe_{1-(x+y)}PO₄, in which 0<x<1, 0<y<1 and x+y<1. In some specific embodiments:
a) 0<x≤0.05, more particularly 0.005≤x≤0.05, 0.005≤x≤0.04, 0.005≤x≤0.03, 0.005≤x≤0.02, 0.01≤x≤0.05, 0.01≤x≤0.04, 0.01≤x≤0.03, 0.01≤x≤0.02, 0.02≤x≤0.05, 0.02≤x≤0.04, 0.02≤x≤0.03, 0.03≤x≤0.05, 03, 0.03≤x≤0.04, or 0.04≤x≤0.05;
b) 0<y≤0.3, more particularly 0.005≤y≤0.3, 0.005≤y≤0.25, 0.005≤y≤0.2, 0.005≤y≤0.16, 0.005≤y≤0.15, 0.005≤y≤0.1, 0.005≤y≤0.05, 0.005≤y≤0.01, 0.01≤y≤0.3, 0.01≤y≤0.25, 0.01≤y≤0.2, 0.01≤y≤0.16, 0.01≤y≤0.15, 0.01≤y≤0.1, 0.01≤y≤0.05, 0.05≤y≤0.3, 0.05≤y≤0.25, 0.05≤y≤0.2, 0.05≤y≤0.16, 0.05≤y≤0.15, 0.05≤y≤0.1, 0.1≤y≤0.3, 0.1≤y≤0.25, 0.1≤y≤0.2, 0.1≤y≤0.16, 0.1≤y≤0.15, 0.15≤y≤0.3, 0.15≤y≤0.25, 0.15≤y≤0.2, 0.15≤y≤0.16, 0.16≤y≤0.3, 0.16≤y≤0.25, 0.16≤y≤0.2, 0.2≤y≤0.3, 0.2≤y≤0.25, or 0.25≤y≤0.3; or
c) 0<x+y≤0.3, more particularly 0.005≤x+y≤0.3, 0.005≤x+y≤0.25, 0.005≤x+y≤0.2, 0.005≤x+y≤0.15, 0.005≤x+y≤0.1, 0.005≤x+y≤0.05, 0.005≤x+y≤0.01, 0.01≤x+y≤0.3, 0.01≤x+y≤0.25, 0.01≤x+y≤0.2, 0.01≤x+y≤0.15, 0.01≤x+y≤0.1, 0.01≤x+y≤0.05, 0.05≤x+y≤0.3, 0.05≤x+y≤0.25, 0.05≤x+y≤0.2, 0.05≤x+y≤0.15, 0.05≤x+y≤0.1, 0.1≤x+y≤0.3, 0.1≤x+y≤0.25, 0.1≤x+y≤0.2, 0.1≤x+y≤0.15, 0.15≤x+y≤0.3, 0.15≤x+y≤0.25, 0.15≤x+y≤0.2, 0.2 x+y≤0.3, 0.2≤x+y≤0.25, or 0.25≤x+y≤0.3.

In any embodiments, particularly those of a), b), or c) the ratio of x:y may be in a range between 5:1 and 1:5, more particularly between 5:1 and 1:3, 5:1 and 1:1, 5:1 and 3:1, 3:1 and 1:5, 3:1 and 1:3, 3:1 and 1:1, 1:1 and 1:5, 1:1 and 1:3, 1:3 and 1:5.

In more specific embodiments, the ratio of x:y may be in a range between 1:2 and 1:5, more particularly between 1:2 and 1:4, 1:2 and 1:3, 1:3 and 1:5, 1:3 and 1:4, or 1:4 and 1:5.

In other more specific embodiments, the ratio of x:y may be in a range between 5:1 and 1:2, more particularly between 5:1 and 1:1, 4:1 and 1:2, 4:1 and 1:1, 3:1 and 1:2, 3:1 and 1:1, 2:1 and 1:2, and 2:1 and 1:1.

In a more specific embodiment, the materials have the chemical formula Mn_{0.04}Ni_{0.16}Fe_{0.8}PO₄.

Metal phosphate cathode active materials 50b may include FP. In some embodiments, FP has the general chemical formula FePO₄.

Metal phosphate cathode active materials 50b may include FCP. In some embodiments, FCP has the general chemical formula Fe₁₋ₓCoₓPO₄, in which 0<x<1. In some specific embodiments, x≥0.05, x≥0.1, x≥0.2, x≥0.3, x≥0.4, x≥0.5, x≥0.6, x≥0.7, x≥0.8, x≥0.9, or x≥0.95.

In some embodiments, FMCP has the general chemical formula Fe_{1-(x+y)}MnₓCo_{y}PO₄, in which 0<x<1, 0<y<1 and x+y<1. In some specific embodiments, a) 0≤x≤0.5, more particularly 0.05≤x≤0.50, 0.05≤x≤0.25, 0.05≤x≤0.2, 0.05≤x≤0.15, 0.05≤x≤0.1, 0.1≤x≤0.5, 0.1≤x≤0.25, 0.1≤x≤0.2, or 0.1≤x≤0.15; b) 0≤y≤0.95, more particularly 0.05≤y≤0.95, 0.05≤y≤0.9, 0.05≤y≤0.75, 0.05≤y≤0.5, 0.05≤y≤0.25, 0.05≤y≤0.1, 0.1≤y≤0.95, 0.1≤y≤0.9, 0.1≤y≤0.75, 0.1≤y≤0.5, or 0.1≤y≤0.25; or c) 0≤x+y≤0.95, more particularly 0.05≤x+y≤0.95, 0.05≤x+y≤0.75, 0.05≤x+y≤0.5, 0.05≤x+y≤0.25, 0.05≤x+y≤0.1, 0.1≤x+y≤0.95, 0.1≤x+y≤0.9, 0.1≤x+y≤0.75, 0.1≤x+y≤0.5, or 0.1≤x+y≤0.25.

In any embodiments, particularly those of a), b), or c) the ratio of x:y may be in a range between 5:1 and 1:5, more particularly between 5:1 and 1:3, 5:1 and 1:1, 5:1 and 3:1, 3:1 and 1:5, 3:1 and 1:3, 3:1 and 1:1, 1:1 and 1:5, 1:1 and 1:3, 1:3 and 1:5.

In more specific embodiments, the ratio of x:y may be in a range between 1:2 and 1:5, more particularly between 1:2 and 1:4, 1:2 and 1:3, 1:3 and 1:5, 1:3 and 1:4, or 1:4 and 1:5.

In other more specific embodiments, the ratio of x:y may be in a range between 5:1 and 1:2, more particularly between 5:1 and 1:1, 4:1 and 1:2, 4:1 and 1:1, 3:1 and 1:2, 3:1 and 1:1, 2:1 and 1:2, and 2:1 and 1:1.

Both lithium metal phosphate cathode active materials 50a and metal phosphate cathode active materials 50b may exhibit an olivine crystal structure, similar to that of LFP, but with gaps in place of lithium ions when the active material is unlithiated. More particularly, the cathode active materials 50 may have an orthorhombic crystal structure of space group Pnma, sometimes referred to as an olivine structure. Although FP, MFP, MNFP, FCP, FMCP and other metal phosphates may exist in alternative crystal structures, such structures are unable to intercalate lithium ions at all, or at least as well as an olivine structure, and are therefore not readily able to intercalate excess lithium ions. Accordingly, in some embodiments, the metal phosphate cathode active material 50b predominantly exhibits an olivine crystal structure. More specifically, about 95 mole % or more of the metal phosphate cathode active material 50b has an olivine crystal structure. In even more specific embodiments, between about 95 mole % and about 99.99 mole %, between about 95 mole % and about 99.9 mole %, between about 95 mole % and about 99 mole %, between about 98 mole % and about 99.99 mole %, between about 98 mole % and about 99.9 mole %, or between about 98 mole % and about 99 mole % of the metal phosphate cathode active material 50b exhibits an olivine crystal structure.

In some embodiments, the cathode active materials of the present disclosure are particles of lithium metal phosphate or metal phosphate coated with a conductive carbon layer which is bonded to the lithium metal phosphate or metal phosphate. It is well understood that a conductive carbon layer is needed for LMFP, LMNFP, LFMCP, LFCP, LFP, MFP, MNFP, FMCP, FCP, or FP to be electrochemically active in a cathode, and the conductive carbon layer may be any type suitable for this purpose. In addition, the conductive carbon layer may be formed using any process that results in a suitable conductive carbon layer, including both processes performed on existing lithium metal phosphates or metal phosphates and processes in which the lithium metal phosphate or metal phosphate and conductive carbon layer are both formed during the same process, as well as processes that include reducing, oxidizing, or inert atmospheres. In some embodiments, the conductive carbon layer is present in a wt % of between about 0.5 wt % and about 3 wt % of the total weight of lithium metal phosphate or metal phosphate and carbon layer.

In more specific embodiments, the conductive carbon layer may be present in a wt % between about 0.5 wt % and about 2 wt %, between about 0.5 wt % and about 1 wt %, between about 1 wt % and about 3 wt %, between about 1 wt % and about 2 wt %, or between about 2 wt % and about 3 wt %.

Except in embodiments where solely the lithium metal phosphate or metal phosphate is being described (e.g. the chemical formula of LMFP), the “cathode active material” includes any carbon coating. For example, when the wt % of LMFP in a cathode material combination or cathode layer is discussed, the relevant LMFP weight includes any conductive carbon coating on the underlying lithium manganese iron phosphate.

In some embodiments, the cathode 20 includes a LMFP 50a and a MFP 50b. The LMFP may be present in a weight % (wt %) as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. The MFP may be present in a wt % as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. In a more specific embodiment, the LMFP may be present in a wt % between about 80 wt % and about 99 wt %, more specifically between about 80 wt % and about 95 wt %, between about 80 wt % and about 90 wt %, between about 80 wt % and about 85 wt %, between about 85 wt % and about 99 wt %, between about 85 wt % and about 90 wt %, between about 90 wt % and about 99 wt %, or between about 95 wt % and about 99 wt %; and the MFP may be present in a wt % between about 1 wt % and about 20 wt %, more specifically between about 1 wt % and about 15 wt %, between about 1 wt % and about 10 wt %, between about 1 wt % and about 5 wt %, between about 5 wt % and about 20 wt %, between about 5 wt % and about 15 wt %, between about 5 wt % and about 10 wt %, between about 10 wt % and about 20 wt %, between about 10 wt % and about 15 wt %, or between about 15 wt % and about 20 wt %. In a more specific embodiment, the cathode 20 may have two cathode active materials 50a and 50b that consist of LMFP and MFP, respectively, in any of the wt % ranges specified above, such that the total wt % of LMFP and MFP is 100 wt %.

Alternately, in some embodiments, the cathode 20 includes a LMNFP 50a and a MNFP 50b in which the LMNFP is present in the same ranges as disclosed in the paragraph above for LMFP and the MNFP is present in the same ranges as disclosed in the paragraph above for MFP. In a more specific embodiment, the cathode 20 may have two cathode active materials 50a and 50b that consist of LMNFP and MNFP, respectively, in any of the wt % ranges specified above, such that the total wt % of LMNFP and MNFP is 100 wt %.

In some embodiments, the relative amounts of Mn and Fe in the LMFP and the MFP may be the same, such that, for example, if LMFP has the general chemical formula Li Mn_{0.3}Fe_{0.7}PO₄, then MFP has the general formula Mn_{0.3}Fe_{0.7}PO₄, or if LMFP has the general chemical formula Li Mn_{0.2}Fe_{0.8}PO₄, then MFP has the general formula Mn_{0.2}Fe_{0.8}PO₄ Alternatively, in some embodiments, the same condition may also exist for LMNFP and MNFP combinations.

In some embodiments, the relative amounts of Mn and Fe in the LMFP and MFP may differ. For example, the LMFP may have the general chemical formula Li Mn_{0.3}Fe_{0.7}PO₄, while the MFP has the general formula Mn_{0.2}Fe_{0.8}PO₄. Alternatively, in some embodiments, the same condition may also exist for LMNFP and MNFP combinations.

Alternately, in some embodiments, the cathode 20 includes a LMNFP 50a and a MFP 50b in which the LMNFP is present in the same ranges as disclosed in the paragraph above for LMFP and the MFP is present in the same ranges as disclosed in the paragraph above in connection with the combination of LMFP and MFP. In a more specific embodiment, the cathode 20 may have two cathode active materials 50a and 50b that consist of LMNFP and MFP, respectively, in any of the wt % ranges specified above, such that the total wt % of LMNFP and MFP is 100 wt %.

In some embodiments, the cathode 20 includes a LMFP 50a and a FP 50b. The LMFP may be present in a weight % (wt %) as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, or 90 wt %. The FP may be present in a wt % as compared to total cathode active material weight between about 5 wt % and about 95 wt %, including ranges therein with endpoints of about 10, 15, 20, 25, 30, 35, 40, 45, 50, 55, 60, 65, 70, 75, 80, 85, or 90 wt %. In a more specific embodiment, the LMFP may be present in a wt % between about 80 wt % and about 99 wt %, more specifically between about 80 wt % and about 95 wt %, between about 80 wt % and about 90 wt %, between about 80 wt % and about 85 wt %, between about 85 wt % and about 99 wt %, between about 85 wt % and about 90 wt %, between about 90 wt % and about 99 wt %, or between about 95 wt % and about 99 wt %; and the FP may be present in a wt % between about 1 wt % and about 20 wt %, more specifically between about 1 wt % and about 15 wt %, between about 1 wt % and about 10 wt %, between about 1 wt % and about 5 wt %, between about 5 wt % and about 20 wt %, between about 5 wt % and about 15 wt %, between about 5 wt % and about 10 wt %, between about 10 wt % and about 20 wt %, between about 10 wt % and about 15 wt %, or between about 15 wt % and about 20 wt %. In a more specific embodiment, the cathode 20 includes two active materials 50a and 50b that consist of LMFP and FP, respectively, in any of the wt % ranges specified above, such that the total wt % of LMFP and FP is 100 wt %.

Alternately, in some embodiments, the cathode 20 includes a LMNFP 50a and a FP 50b in which the LMNFP is present in the same ranges as disclosed in the paragraph above for LMFP and the FP is present in the same ranges as disclosed in the paragraph above in connection with the combination of LMFP and FP. In a more specific embodiment, the cathode 20 may have two cathode active materials 50a and 50b that consist of LMNFP and FP, respectively, in any of the wt % ranges specified above, such that the total wt % of LMNFP and FP is 100 wt %.

In some embodiments, the cathode 20 includes a LMFP 50a, and two metal phosphates 50b, a first metal phosphate 50b-1, MFP, and a second metal phosphate 50b-2, FP. The LMFP may be present in a weight % (wt %) as compared to total cathode active material weight between about 5 wt % to about 90 wt %, including ranges therein with endpoints of about 10, 15, 20, 25, 30, 35, 40, 45, 50, 55, 60, 65, 70, 75, 80, or 85 wt %. The MFP may be present in a wt % as compared to total cathode active material weight between about 5 wt % to about 90 wt %, including ranges therein with endpoints of about 10, 15, 20, 25, 30, 35, 40, 45, 50, 55, 60, 65, 70, 75, 80, or 85 wt %. The FP may be present in a wt % as compared to total cathode active material weight between about 5 wt % to about 90 wt %, including ranges therein with endpoints of about 10, 15, 20, 25, 30, 35, 40, 45, 50, 55, 60, 65, 70, 75, 80, or 85 wt %. In a more specific embodiment, the LMFP may be present in a wt % between about 80 wt % and about 98 wt %, more specifically between about 80 wt % and about 95 wt %, between about 80 wt % and about 90 wt %, between about 80 wt % and about 85 wt %, between about 85 wt % and about 98 wt %, between about 85 wt % and about 90 wt %, between about 90 wt % and about 98 wt %, or between about 95 wt % and about 98 wt %; the MFP may be present in a wt % between about 1 wt % and about 20 wt %, more specifically between about 1 wt % and about 15 wt %, between about 1 wt % and about 10 wt %, between about 1 wt % and about 5 wt %, between about 5 wt % and about 20 wt %, between about 5 wt % and about 15 wt %, between about 5 wt % and about 10 wt %, between about 10 wt % and about 20 wt %, between about 10 wt % and about 15 wt %, or between about 15 wt % and about 20 wt %; and the FP may be present in a wt % between about 1 wt % and about 20 wt %, more specifically between about 1 wt % and about 15 wt %, between about 1 wt % and about 10 wt %, between about 1 wt % and about 5 wt %, between about 5 wt % and about 20 wt %, between about 5 wt % and about 15 wt %, between about 5 wt % and about 10 wt %, between about 10 wt % and about 20 wt %, between about 10 wt % and about 15 wt %, or between about 15 wt % and about 20 wt %. In a more specific embodiment, the cathode 20 includes three active materials 50a, a first 50b-1, and a second 50b-2 that consist of LMFP, MFP, and FP, respectively, in any of the wt % ranges specified above, such that the total wt % of LMFP, MFP, and FP, is 100 wt %.

Alternately, in some embodiments, the cathode 20 includes a LMNFP 50a and a MFP 50b-1 and a FP 50b-2, in which the LMNFP is present in the same ranges as disclosed in the paragraph above for LMFP and the MFP and FP are present in the same ranges as disclosed in the paragraph above in connection with the combination of LMFP with MFP and FP. In a more specific embodiment, the cathode 20 includes three active materials 50a, a first 50b-1, and a second 50b-2 that consist of LMNFP, MFP, and FP, respectively, in any of the wt % ranges specified above, such that the total wt % of LMFP, MFP, and FP, is 100 wt %.

The present disclosure further provides a cathode 20 in which LMFP, LMNFP, or a combination thereof are present as a cathode material 50a (or two cathode materials 50a-1 and 50a-2) in a cathode material 50a total weight % (wt %) as compared to total cathode active material weight between about 5 wt % to about 90 wt %, including ranges therein with endpoints of about 10, 15, 20, 25, 30, 35, 40, 45, 50, 55, 60, 65, 70, 75, 80, or 85 wt %; an in which MFP, MNFP, FP, or any combinations thereof are present as a cathode material 50b (or at least two cathode materials 50b-1, 50b-2 and, optionally 50b-[3 to 6]) in a cathode material 50b total weight % (wt %) as compared to total cathode active material weight between about 5 wt % to about 90 wt %, including ranges therein with endpoints of about 10, 15, 20, 25, 30, 35, 40, 45, 50, 55, 60, 65, 70, 75, 80, or 85 wt %. In more specific embodiments, each of the MFP, MNFP, FP, if present, may be present in weight 5 (wt %) as compared to total cathode active material weight between about 5 wt % to about 89.9 wt %, including ranges therein with endpoints of about 10, 15, 20, 25, 30, 35, 40, 45, 50, 55, 60, 65, 70, 75, 80, or 85 wt %.

In some embodiments the cathode may contain at least two distinct cathode active materials or mixtures of cathode active materials in the form of a bipolar cathode, with at least one and, in some embodiments, all, such cathode active materials as described herein.

In more specific embodiments, Li may be present in an amount between 1 wt % and 20 wt %, about 5 wt % and 20 wt %, about 10 wt % and 50 wt %, or about 15 wt % and 20 wt %. In such embodiments, the anode may not contain lithium ion or lithium metal. In some embodiments, Li may be present in these amounts in the cathode or in the entire cell and the anode may include a lithium reservoir.

In some embodiments, LFP, LMFP, LMNFP, LFCP, LFMCP, FP, MFP, MNFP, FCP, or FMCP may include additional elements included in their crystal structures. These additional elements may affect electrical conductivity and/or lithium ion intercalation of the cathode active material. Additional elements may have or be capable of existing in a charge state equal to that of the element replaced in the crystal structure. For example, iron may be replaced with another element that may exist in a 2+ or 3+ charge state. The additional element may be a transition metal also able to move from one charge to another during an electrochemical reaction, or if may be a fixed valence material, such as a fixed-valence 2+ metal in place of iron. Phosphorus may also be replaced, where present with sulfur or silicon. The amount of transition metal replaced by another metal may be 10%, 5%, 2%, 1%, 0.5%, or 0.1% or less, or in a range of 0.1% to 10%, 0.1% to 5%, 0.1% to 2%, 0.1% to 1%, 0.1% to 0.5%, 0.5% to 5%, 0.5% to 2%, 0.5% to 1%, 1% to 5%, 1% to 2%, or 2% to 5%.

In some embodiments, at least one cathode active material 50 can be coated or doped with an inorganic fluoride composition that is not electrochemically active at the operation parameters of the cell. Doped, in this context, means that the inorganic fluoride composition is admixed with the cathode active material, but not chemically bonded to the active material. The inorganic fluoride composition may improve energy density or cycle life of cells containing the cathode 20 as compared to cells with the same cathode lacking the inorganic fluoride composition. In a specific embodiment, the fluoride composition may increase the number of times the cell may be cycled before experiencing about 25% capacity loss as compared to capacity at the 10^{th} cycle, while changing the energy density of the cell about 10% or less, about 5% or less, about 1% or less, between about 10% and about 0.1%, between about 5% and 0.1%, or between about 1% and 0.1%. Testing may be performed in a test cell as set forth below with respect to energy density testing.

A coating may also decrease the irreversible capacity loss exhibited by the cell 10 upon the first cycle.

Without being limited to a particular theory, the coating may stabilize the crystal lattice of the cathode active material during intercalation and de-intercalation of lithium ions to reduce irreversible changes in the crystal lattice.

Although coating or doping a cathode active material can improve the capacity of a cell containing the cathode active material, the coating itself is not electrochemically active at the operational parameters of the cell. Therefore, when the loss of specific capacity due to the amount of coating or doping material added to a cathode active material exceeds where the benefit of adding coating or doping material, reduction in cell capacity can be expected. In general, the amount of coating or doping material added to the cathode active material can be selected to balance the beneficial stabilization resulting from the coating or doping with the loss of specific capacity due to the weight of the coating or doping material that generally does not contribute directly to a high specific capacity of the material.

In some embodiments, for a cathode active material with a coating or dopant, the amount of coating or dopant or of the cathode active material is between about 10 mole % and about 90 mole % of the combined cathode active material and coating or dopant. In more specific embodiments, the amount of coating or dopant or of the cathode active material is between about 10 mole % and about 75 mole %, about 10 mole % and about 50 mole %, about 25 mole % and about 90 mole %, about 25 mole % and about 75 mole %, about 25 mole % and about 50 mole %, about 50 mole % and about 90 mole %, about 50 mole % and about 75 mole %, 70 mole % and about 85 mole %, between about 70 mole % and about 80 mole %, between about 70 mole % and about 75 mole %, between about 75 mole % and about 90 mole %, between about 75 mole % and about 85 mole %, between about 75 mole % and about 80 mole %, between about 80 mole % and about 90 mole %, between about 80 mole % and about 85 mole %, or between about 85 mole % and about 90 mole %. Suitable amounts of coating or dopant may facilitate operating of cell 10 by improving ionic or electronic conductivity of the cathode 20.

Suitable coating materials include metal fluorides, metalloid fluorides, and any combinations thereof. It has been found that metal/metalloid fluoride coatings can significantly improve the performance of lithium rich layered compositions for lithium ion secondary batteries as demonstrated in the examples in U.S. application Ser. No. 12/246,814 and U.S. application Ser. No. 12/332,735, both incorporated herein by reference in their entireties.

Suitable metals and metalloid elements in the metal fluorides or metalloid fluorides include Al, Bi, Ga, Ge, In, Mg, Pb, Si, Sn, Ti, Tl, Zn, Zr and combinations thereof.

Suitable metal fluorides and metalloid fluorides include CsF, KF, LiF, NaF, RbF, TiF, AgF, AgF₂, BaF₂, CaF₂, CuF₂, CdF₂, FeF₂, HgF₂, Hg₂F₂, MnF₂, MgF₂, NiF₂, PbF₂, SnF₂, SrF₂, XeF₂, ZnF₂, AlF₃, BF₃, BiF₃, CeF₃, CrF₃, DyF₃, EuF₃, GaF₃, GdF₃, FeF₃, HoF₃, LnF₃, LaF₃, LuF₃, MnF₃, NdF₃, VOF₃, PrF₃, SbF₃, ScF₃, SmF₃, TbF₃, TiF₃, YF₃, YbF₃, CeF₄, GeF₄, HfF₄, SiF₄, SnF₄, TiF₄, VF₄, ZrF₄, NbF₅, SbF₅, TaF₅, BiF₅, MoF₆, ReF₆, SF₆, WF₆, and any combinations thereof.

In more specific embodiments, the metal fluorides may be LiF, ZnF₂, AlF₃, and any combinations thereof. AlF₃ may be particularly useful due to its reasonable cost and low negative environmental impact.

When used as coatings, metal fluorides and metalloid fluorides may be applied as is known for LiCoO₂ and LiMn₂O₄, for example as described in WO 2006/1109930A, which is incorporated by reference herein, particularly with respect to such coatings and application methods.

The cathode active materials 50a and 50b may be in the form of particles, which may be nanoparticles, microparticles, or agglomerates. Particle size includes any coating on active materials 50a and 50b. Cathode active materials 50a and 50b may have about the same particle size or different particle sizes and similarly may be agglomerated or non-agglomerated, or one particle type may be agglomerated while the other(s) is/are not.

In some embodiments, the cathode 20, when used in a test electrochemical cell having a cathode including 10 wt % or less, as compared to total weight of binder and cathode active material, binder mixed with the cathode active material, a graphite and silicon anode and an electrolyte that includes a lithium salt in an appropriate solvent with additives (such as 0.5 M LiPF₆+LiFSI in EC+DEC+VC+FEC), with a polypropylene separator and copper and aluminum metal foil current collectors, has a discharge energy density of 200 Wh/kg or 250 Wh/kg or more when discharged from 4.2V to 2.5V at C/3. In more specific embodiments, the discharge energy density is between 200 Wh/kg and about 800 wH/kg, 250 Wh/kg and about 800 Wh/kg, between 250 Wh/kg and about 700 Wh/kg, between 250 Wh/kg and about 600 Wh/kg, between 250 Wh/kg and about 500 Wh/kg, between 250 Wh/kg and about 400 Wh/kg, or between 250 Wh/kg and about 300 Wh/kg. In more specific embodiments, the discharge energy density is at least 400 Wh/kg when discharged from 4.2V to 2.5V, more specifically between 300 Wh/kg and about 500 Wh/kg. In some embodiments, these discharge energy densities may be observed in a cell discharged at a discharge rate of C/3 at the tenth discharge/charge cycle at 23° C. when discharged from 2.5 V. In other embodiments these discharge energy densities may be observed in a cell discharged at a discharge rate of C/10 at the tenth discharge/charge cycle at 23° C. when discharged from 2.5 V.

More specifically, the energy density is measured at a cell cycle later than the first cycle, to address first cycle effects. In a more specific embodiment, it is measured at a cycle in the range of cycles where cycle-to-cycle variation in measured energy density is less than 5%. In another more specific embodiment, energy density is measured at a cell cycle that is the tenth cycle or later.

In more specific embodiments, the discharge energy density may vary by 10% or less during discharge at a temperature in the range between about −40° C. and about 85° C. In more specific embodiments, the discharge energy density may vary by between about 0.01% and about 10%, between about 0.1% and about 10%, between about 1% and about 10%, between about 0.01% and about 7.5%, between about 0.1% and about 7.5%, between about 1% and about 5%, between about 0.01% and about 5%, between about 0.1% and about 5%, between about 1% and about 5%, between about 0.01% and about 2.5%, between about 0.1% and about 2.5%, or between about 1% and 2.5%.

In other more specific embodiments, which may be combined with any of the variation ranges above, the temperature may be between about −40° C. and about 60° C., between about −40° C. and about 50° C., between about −40° C. and about 45° C., between about −40° C. and about 40° C., between about −30° C. and about 85° C., between about −30° C. and about 60° C., between about −30° C. and about 50° C., between about −30° C. and about 45° C., between −30° C. and 40° C., between about −20° C. and about 85° C., between about −23° C. and about 60° C., between about −23° C. and about 50° C., between about −23° C. and about 45° C., between about −23° C. and about 40° C., between about −10° C. and about 85° C., between about −10° C. and about 60° C., between about −10° C. and about 50° C., between about −10° C. and about 45° C., or between about −20° C., and about 40° C.

In some embodiments, the cathode 20, when used in the test electrochemical cell, has a volumetric discharge energy density of 500 Wh/L or more or 600 Wh/L or more. In more specific embodiments, the volumetric discharge energy density is between 500 Wh/L and about 900 Wh/L, 500 Wh/L and about 800 Wh/L, 500 Wh/L and about 700 Wh/L, 500 Wh/L and about 600 Wh/L, 600 Wh/L and about 900 Wh/L, 600 Wh/L and about 800 Wh/L, or 600 Wh/L and about 700 Wh/L. These volumetric energy densities may vary by the same amounts over the same temperature ranges as recited above with respect to discharge energy density. In some embodiments, these volumetric discharge energy densities may be observed in a cell discharged at a discharge rate of C/3 at the tenth discharge/charge cycle at 23° C. when discharged from 2.5 V. In other embodiments these volumetric discharge energy densities may be observed in a cell discharged at a discharge rate of C/10 at the tenth discharge/charge cycle at 23° C. when discharged from 2.5 V.

In further embodiments, the cell can have a volumetric discharge energy density of at least about 500 Wh/L. In some embodiments, the resultant battery can have a volumetric discharge energy density of at least about 500 Wh/L to 900 Wh/L.

In some embodiments, the cathode 20, when used in the test electrochemical cell, has cycle life of about 500 cycles, about 1000 cycles, or about 5000 cycles or more with a capacity decrease of less than about 25% as compared to the capacity at the 10^{th} cycle. In more specific embodiments, the cathode, when used in a test electrochemical cell, has a cycle life of between about 500 cycles and about 10,000 cycles, between about 1000 cycles and about 10,000 cycles, about 5000 cycles and about 10,000 cycles, about 500 cycles and about 7000 cycles, about 1000 cycles and about 7000 cycles, or about 5000 cycles and about 7000 cycles. These cycle life's may vary by the same amounts over the same temperature ranges as recited above with respect to discharge energy density. In some embodiments, these cycle lifes may be observed in a cell discharged at a discharge rate of C/3 at the tenth discharge/charge cycle at 23° C. when discharged from 2.5 V. In other embodiments these cycle lifes may be observed in a cell discharged at a discharge rate of C/10 at the tenth discharge/charge cycle at 23° C. when discharged from 2.5 V.

Cathodes 20 of some embodiments of the present disclosure may exhibit surprisingly high specific capacities in cells, such as the test cell described above, under realistic discharge conditions. In some embodiments, the cathode 20, when discharged in an electrochemical cell after having been cycled between 10 and 100 times, may exhibit a specific capacity that is about 125 mAh/g or more, about 140 mAh/g or more, about 150 mAh/g or more, about 155 mAh/g or more, about 160 mAh/g or more, about 165 mAh/g or more, or about about 170 mAh/g or more when measured at 23° C. when discharged from 4.2 V. In more specific embodiments, the specific capacity may be between about 125 mAh/g and about 100 mAh/g, about 125 mAh/g and about 175 mAh/g, about 125 mAh/g and about 170 mAh/g, about 125 mAh/g and about 165 mAh/g, about 125 mAh/g and about 160 mAh/g, about 125 mAh/g and about 155 mAh/g, about 125 mAh/g and about 150 mAh/g, about 125 mAh/g and about 140 mAh/g, about 140 mAh/g and about 200 mAh/g, about 140 mAh/g and about 175 mAh/g, about 140 mAh/g and about 170 mAh/g, about 140 mAh/g and about 165 mAh/g, about 140 mAh/g and about 160 mAh/g, about 140 mAh/g and about 155 mAh/g, about 140 mAh/g and about 150 mAh/g, about 150 mAh/g and about 200 mAh/g, about 150 mAh/g and about 175 mAh/g, about 150 mAh/g and about 170 mAh/g, about 150 mAh/g and about 165 mAh/g, about 150 mAh/g and about 160 mAh/g, about 150 mAh/g and about 155 mAh/g, about 155 mAh/g and about 200 mAh/g, about 155 mAh/g and about 175 mAh/g, about 155 mAh/g and about 170 mAh/g, about 155 mAh/g and about 165 mAh/g, about 155 mAh/g and about 160 mAh/g, about 160 mAh/g and about 200 mAh/g, about 160 mAh/g and about 175 mAh/g, about 160 mAh/g and about 170 mAh/g, about 170 mAh/g and about 200 mAh/g, about 170 mAh/g and about 190 mAh/g, about 170 mAh/g and about 180 mAh/g, about 170 mAh/g and 175 mAh/g, about 175 mAh/g and about 200 mAh/g, and about 175 mAh/g and about 180 mAh/g. These specific capacities may vary by the same amounts over the same temperature ranges as recited above with respect to discharge energy density. In some embodiments, these specific capacities may be observed in a cell discharged at a discharge rate of C/3 at the tenth discharge/charge cycle at 23° C. when discharged from 2.5 V. In other embodiments, specific capacities may be observed in a cell discharged at a discharge rate of C/10 at the tenth discharge/charge cycle at 23° C. when discharged from 2.5 V.

In more specific embodiments, the cathode 20 may also have a tap density of about 1.2 g/cm³ or more, about 2.0 g/cm³ or more, or about g/cm³ or more. In more specific embodiments, the tap density may be between about 1.2 g/cm³ and about 5.0 g/cm³, about 1.2 g/cm³ and about 4.0 g/cm³, about 1.2 g/cm³ and about 2.0 g/cm³, about 1.2 g/cm³ and about 1.5 g/cm³, about 2.0 g/cm³ and about 5.0 g/cm³, about 2.0 g/cm³ and about 4.0 g/cm³, or about 2.0 g/cm³ and about 3.0 g/cm³. These tap densities may vary by the same amounts over the same temperature ranges as recited above with respect to discharge energy density. In some embodiments, these tap densities may be observed in a cell discharged at a discharge rate of C/3 at the tenth discharge/charge cycle at 23° C. when discharged from 2.5 V. In other embodiments these tap densities may be observed in a cell discharged at a discharge rate of C/10 at the tenth discharge/charge cycle at 23° C. when discharged from 2.5 V.

In general, when specific capacities are comparable, a higher tap density of a positive electrode material results in a higher overall capacity of a battery.

During charge/discharge measurements, the specific capacity of a material depends on the rate of charge or discharge. The maximum specific discharge capacity of a cell is typically measured at very slow discharge rates. In actual use, the capacity is less than the measured specific discharge capacity due to discharge at a finite rate. More realistic discharge capacities can be measured using reasonable rates of discharge that are more similar to the rates a cell would experience during use. For low to moderate discharge rate uses, a reasonable testing rate involves a discharge of the cell over three hours. In conventional notation this is written as C/3 or 0.33C.

In some embodiments, the cathode 20 used in test cell as described above may have a specific discharge capacity of about 100 mAh/g, about 150 mAh/g, or about 170 mAh/g or more at a discharge rate of C/3 at the tenth discharge/charge cycle at 23° C. when discharged from 2.5 V.

In some embodiments, the cathode 20 used in a test cell as described above may have a specific discharge capacity of about 100 mAh/g, about 150 mAh/g, or about 170 mAh/g or more at a discharge rate of C/10 at the tenth discharge cycle at 23° C. when discharged from 2.5 V.

In either the above embodiment at which the discharge rate is at C/3 or the above embodiment at which the discharge rate is C/10, the cathode 20 may also have a resulting tap density of about 1.5 g/cm³, about 2.0 g/cm³, about 2.5 g/cm³, or about 3.0 g/cm³.

These above properties at various discharge rates may vary by the same amounts over the same temperature ranges as recited above with respect to discharge energy density.

In some embodiments, the cathode active material 50 may be mixed with an additional material to form layer 30. In such embodiments, cathode layer 30 includes at least about 90 wt % cathode active material 50, which, for purposes of this measurement, includes any coating or dopant. More specifically, cathode layer 30 may include between about 90 wt % and about 99 wt %, about 90 wt % and about 98 wt %, about 90 wt % and about 97 wt %, about 90 wt % and about 96 wt %, about 90 wt % and about 95 wt %, cathode active material 50.

Suitable additional materials include polymer binders and conductivity enhancers and combinations thereof.

Suitable conductivity enhancers include carbon fibers, such as vapor grown carbon fibers (VGCF), carbon nanorods, graphite, or carbon blacks, such as acetylene black, Denka black, Ketjen black, hard carbon, silver/gold nano-wires or particles, or any combinations thereof.

In some embodiments, the cathode layer 30 may include 5 wt % or less conductivity enhancer. More specifically, the cathode layer 30 may include between about 1 wt % and about 5 wt %, between about 2 wt % and about 5 wt %, about 1 wt % and about 4 wt %, about 2 wt % and about 4 wt %, or about 3 wt % and about 4 wt % conductivity enhancer.

Suitable polymer binders include binders that adhere the cathode active material 50 or cathode layer 30 to other components of the cathode 20, such as the current collector 40. In some embodiments, the polymer binder may include polyvinylidine fluoride (PVDF), polyethylene oxide, polyethylene, polypropylene, polytetrafluoroethylene, polyacrylates, ethylene-(propylene-diene monomer) copolymer (EPDM), water soluble binder, such as synthetic rubber, particularly styrene-butadiene rubber (SBR), styrene-butadiene rubber/carboxyl methyl-cellulose (SBR/CMC), sodium alginate, or sodium acrylate, silicone, conducting polymers, and any mixtures and copolymers thereof. Conducting polymers may include poly(3,4)ethylene dioxane thiophene (PEDOT), poly-styrene sulfonate (PSS), polyvinyl alcohol (PVA), polyethylene glycol (PEG), polyethylene oxide (PEO), polymethyl methacrylate (PMMA), and any mixtures and copolymers thereof.

In more specific embodiments, the polymer binder may have a molecular weight of about 200 atomic mass units (AMU) or more. More specifically, the polymer binder may have a molecular weight higher than 200 AMU.

In more specific embodiments, the polymer binder may include PVDF with a molecular weight of higher than 200 AMU, or between 200 and 5000 AMU.

In some embodiments, the cathode layer 30 may include 5 wt % or less polymer binder. More specifically, the cathode layer 30 may include between about 1 wt % and about 5 wt %, between about 2 wt % and about 5 wt %, about 1 wt % and about 4 wt %, about 2 wt % and about 4 wt %, or about 3 wt % and about 4 wt % polymer binder.

The density of cathode layer 30 may be about 2 g/mL or more to 3.6 g/mL or more. More specifically, it may be between about 2 g/mL and about 5 g/ML, about 2 g/mL and about 4.5 g/mL, about 2 g/mL and about 4 g/mL, about 2 g/mL and about 3.5 g/mL, about 3.6 g/mL and about 5 g/mL, about 3.6 g/mL and about 4.5 g/mL, or about 3.6 g/mL and about 4 g/mL.

Cathode 20 also includes cathode current collector 40, which may be any suitable electrically conductive material, such as a metal foil, a metal grid, a metal screen, metal foam, expanded metal (which is a metal grid or metal screen that has a thickness sufficient to allow a substantial amount of cathode active material to collect within it), or at least one graphene layer, typically a plurality of graphene layers. In some embodiments, cathode current collector 40 may include Al, Ni, Ti, C, stainless steel, or any combinations thereof. In a specific embodiment, the cathode current collector 40 is aluminum, more specifically aluminum foil. In some embodiments, if the current collector includes or is a metal, it may further include a conductive and corrosion-resistant coating, such as TiN.

Cathode layer 30 is sufficiently adhered to cathode current collector 40 to maintain physical integrity of cathode 20 during the expected life of cell 10, or a battery, such as battery 200, battery 300, or battery 400.

In some embodiments, not depicted, cathode layers may be formed on both sides of the cathode current collector.

In a specific embodiment, the cathode current collector 40 is a plurality of graphene layers.

### Anode

Anode 60, as depicted in FIG. 1, includes anode active material 90 in an anode layer 70.

In some embodiments (not shown), anode layer 70 may be formed entirely of anode active material 90. In other embodiments, an additional material, such as a conductivity enhancer or polymer binder may be present. In anodes 60 where lithium ions plate out as lithium metal, anode layer 70 may include anode active material 90 and plated out lithium metal on anode active material 90, in varying amounts of lithium metal depending on the charge/discharge state of electrochemical cell 10.

In some embodiments, the anode active material 90 may include a lithium intercalating carbon, a metal or metal alloy, a silicon-containing material, a metal oxide, or any combinations thereof. In specific embodiments, the anode active material 90 includes graphite and silicon.

In more specific embodiments containing a metal alloy, the metal alloy may be combined with an intercalation carbon or a conductive carbon.

As depicted in FIG. 1, anode active material 90 includes a first anode active material 90a and a second anode active material 90b. In some embodiments, anode layer 70 may be formed entirely of anode active material 90. In other embodiments, an additional material, such as a conductivity enhancer or binder may be present. In anodes 60 where lithium ions plate out as lithium metal, anode layer 70 may include anode active material 90 and plated out lithium metal on anode active material 90, in varying amounts of lithium metal depending on the charge/discharge state of electrochemical cell 10. In particular embodiments, lithium metal may intercalate, as with a graphite anode active material 90, or alloy, as with a silicon anode active material 90.

In some embodiments, the first anode active material 90a and the second anode active material 90b may include or individually consist of a graphite, natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, including a single-walled carbon nanotube, hard carbon, or hard carbon and amorphous silicon or silicon nanotubes, or any combinations thereof, provided that the first anode active material 90a and the second anode active material 90b are not identical. In some embodiments, the first anode active material 90a and the second anode active material 90b may be different types of material (e.g. they may not both be synthetic graphites). In some embodiments, the first anode active material 90a and the second anode active material 90b may be the same type of material, but have different chemical compositions or electric properties (e.g. they may both be graphenes, but with different functional groups or difference electric conductivities). In more particular embodiments, the first anode active material 90a and the second anode active material 90b may include or individually consist of natural graphite, synthetic graphite, silicon, graphene, carbon nanotubes (particularly single-walled carbon nanotubes), or any combinations thereof.

In some embodiments, the first anode active material 90a may be a synthetic graphite (or, in a first alternative embodiment graphene, or in a second alternative embodiment, a carbon nanotube, particularly a single-walled carbon nanotubes (SWCN) may be present in the place of synthetic graphite) and may be present in a weight % (wt %) as compared to total anode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. The second anode active material 90b may be a natural graphite and may be present in a wt % as compared to total anode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. In a more specific embodiment, the anode active material 90 or anode layer 70 include a first anode active material 90a and a second anode active material 90b that consist of a synthetic graphite (or, in a first alternative embodiment graphene, or in a second alternative embodiment, a carbon nanotube, particularly a single-walled carbon nanotubes (SWCN) may be present in the place of synthetic graphite) and a natural graphite in any of the wt % ranges specified above, such that the total wt % of synthetic graphite and natural graphite is 100 wt %.

In some embodiments, the first anode active material 90a may be a synthetic graphite a (or, in a first alternative embodiment graphene, or in a second alternative embodiment, a carbon nanotube, particularly a single-walled carbon nanotubes (SWCN) may be present in the place of synthetic graphite) and may be present in a weight % (wt %) as compared to total anode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. The second anode active material 90b may be silicon and may be present in a wt % as compared to total anode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. In a more specific embodiment, the anode active material 90 or anode layer 70 include a first anode active material 90a and a second anode active material 90b that consist of a synthetic graphite (or, in a first alternative embodiment graphene, or in a second alternative embodiment, a carbon nanotube, particularly a single-walled carbon nanotubes (SWCN) may be present in the place of synthetic graphite) and silicon in any of the wt % ranges specified above, such that the total wt % of synthetic graphite and silicon is 100 wt %.

In some embodiments, the first anode active material 90a may be a natural graphite and may be present in a weight % (wt %) as compared to total anode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. The second anode active material 90b may be silicon and may be present in a wt % as compared to total anode active material weight between about 5 wt % and about 95 wt %, including ranges therein with endpoints of about 10, 15, 20, 25, 30, 35, 40, 45, 50, 55, 60, 65, 70, 75, 80, 85, 90 wt %. In a more specific embodiment, the anode active material 90 or anode layer 70 include a first anode active material 90a and a second anode active material 90b that consist of a natural graphite and silicon in any of the wt % ranges specified above, such that the total wt % of natural graphite and silicon is 100 wt %.

In some embodiments, not shown, there may be three anode active materials 90. The first anode active material may be a synthetic graphite (or, in a first alternative embodiment graphene, or in a second alternative embodiment, a carbon nanotube, particularly a single-walled carbon nanotubes (SWCN) may be present in the place of synthetic graphite) and may be present in a weight % (wt %) as compared to total anode active material weight between about 5 wt % and about 90 wt %, including ranges therein with endpoints of about 10, 15, 20, 25, 30, 35, 40, 45, 50, 55, 60, 65, 70, 75, 80, 85 wt %. The second anode active material may be a natural graphite and may be present in a wt % as compared to total anode active material weight between about 5 wt % and about 90 wt %, including ranges therein with endpoints of about 10, 15, 20, 25, 30, 35, 40, 45, 50, 55, 60, 65, 70, 75, 80, 85 wt %. The third anode active material may be silicon and may be present in a wt % as compared to total anode active material weight between about 5 wt % and about 90 wt %, including ranges therein with endpoints of about 10, 15, 20, 25, 30, 35, 40, 45, 50, 55, 60, 65, 70, 75, 80, 85 wt %. In a more specific embodiment, the anode active material 90 or anode layer 70 include a first anode active material, and a second anode active material, and a third anode active material that consist of a synthetic graphite, a natural graphite, and silicon in any of the wt % ranges specified above, such that the total wt % of synthetic graphite, natural graphite, and silicon is 100 wt %.

In some embodiments, anode active material 90, anode layer 70, or anode 60 may lack any lithium metal or lithium ion prior to assembly into cell 10 or prior to the first charge/discharge cycle e.g. when the anode is uncycled. The absence of lithium metal helps preserve excess lithium ion intercalation capacity in the cathode 20 for use if overcharge occurs. In other cases, the anode may include Li+ or Li in the form of a reservoir to supply additional Li+ if the solid electrolyte interface (SEI) consumes too much Li+ during formation.

In a specific embodiment, the anode active material 90 includes a graphite, natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, including a single-walled carbon nanotube, hard carbon, or hard carbon and amorphous silicon or silicon nanotubes, or any combinations thereof.

In more specific embodiments containing a metal alloy, the metal alloy may be combined with an intercalation carbon or a conductive carbon.

In some more specific embodiments, the anode layer 70 may include a cathode active material as an additive. In an even more specific embodiment, the cathode active material may be LFP, lithium manganese iron phosphate, lithium nickel manganese iron phosphate, or their non-lithiated analogs.

In some embodiments, the anode may include a conductivity enhancer, polymer binder, other additive, or combinations thereof.

Suitable conductivity enhancers include carbon fibers, such as vapor grown carbon fibers (VGCF), carbon nanorods, graphite, or carbon blacks, such as acetylene black, Denka black, Ketjen black, hard carbon, silver/gold nano-wires or particles, or any combinations thereof.

In some embodiments, the polymer binder may include polyvinylidine fluoride (PVDF), polyethylene oxide, polyethylene, polypropylene, polytetrafluoroethylene, polyacrylates, ethylene-(propylene-diene monomer) copolymer (EPDM), water soluble binder, such as synthetic rubber, particularly styrene-butadiene rubber (SBR), styrene-butadiene rubber/carboxyl methyl-cellulose (SBR/CMC), sodium alginate, or sodium acrylate, silicone, conducting polymers, and any mixtures and copolymers thereof. Conducting polymers may include poly(3,4)ethylene dioxane thiophene (PEDOT), poly-styrene sulfonate (PSS), polyvinyl alcohol (PVA), polyethylene glycol (PEG), polyethylene oxide (PEO), polymethyl methacrylate (PMMA), and any mixtures and copolymers thereof.

In more specific embodiments, the polymer binder may have a molecular weight of about 200 atomic mass units (AMU) or more. More specifically, the polymer binder may have a molecular weight higher than 200 AMU.

In some embodiments, anode layer 70 has a thickness of between about 2 microns and about 8 microns, about 2 microns and about 6 microns, about 2 microns and about 4 microns, about 4 microns and about 8 microns, about 4 microns and about 6 microns, about 6 microns and about 8 microns, or about 2 microns and about 100 microns.

In some embodiments, not shown, the anode has an anode layer on both sides of the current collector. In more specific embodiments, such an anode has a thickness of between about 2 microns and about 1000 microns, about 2 microns and about 8 microns, about 2 microns and about 6 microns, about 2 microns and about 4 microns, about 4 microns and about 8 microns, about 4 microns and about 6 microns, about 6 microns and about 8 microns, about 2 microns and about 500 microns, or about 2 microns and about 100 microns.

In some embodiments, the anode layer 70 has a total anode active material 90 loading of between about 1 mg/cm² and about 100 mg/cm² total or per side, if both sides have cathode active material.

In some embodiments, the anode layer 70 has a density of between about 0.5 g/mL and about 3 g/mL, about 0.5 g/mL and about 2.5 g/mL, about 0.5 g/mL and about 2 g/mL, about 1 g/mL and about 3 g/mL, about 1 g/mL and about 2.5 g/mL, about 1 g/mL and about 2 g/mL, about 1 g/mL and about 100 g/mL, more specifically between about 1 g/mL and about 75 g/mL, about 1 g/mL and about 50 g/mL, about 1 g/mL and about 25 g/mL, about 25 g/mL and about 100 g/mL, about 25 g/mL and about 75 g/mL, about 25 g/mL and about 50 g/mL, about 50 g/mL and about 100 g/mL, about 50 g/mL and about 75 g/mL, or about 75 g/mL and about 100 g/mL.

Anode 60 may include an anode current collector 80, which may be any suitable electrically conductive material, such as a metal foil, a metal grid, a metal screen, metal foam, expanded metal (which is a metal grid or metal screen that has a thickness sufficient to allow a substantial amount of cathode active material to collect within it), or at least one graphene layer, typically a plurality of graphene layers. In some embodiments, anode current collector 80 may include Cu, Ni, Ti, C, stainless steel, or any combinations thereof. In a specific embodiment, the anode current collector 80 is copper, more specifically copper foil. In some embodiments, if the current collector includes or is a metal, it may further include a conductive and corrosion-resistant coating, such as TiN.

In some embodiments, where anode layer 70 is sufficiently conductive, anode 60 may lack a separate anode current collector 80.

In embodiments that include an anode current collector 80, anode layer 70 is sufficiently adhered to anode current collector 80 to maintain physical integrity of anode 60 during the expected life of cell 10, or a battery, such as battery 200, battery 300, or battery 400.

In a specific embodiment, the anode current collector 80 is a plurality of graphene layers.

In some embodiments, the anode may include graphite, silicon, or both in the form or particles or separate layers.

In some embodiments, the anode is a high capacity lithium ion anodes that includes a lithium reservoir, such as a graphite-silicon composition anode active material along with a lithium reservoir. The lithium reservoir, in various embodiments, may be lithium metal present in the anode, but not intercalated in the graphite-silicon composition, such as lithium particles or foil, or a lithium salt present in the anode as either free lithium salt or coated on the graphite-silicon composition, or any combinations thereof. It will be understood by one of skill in the art that these initial anode structures exist prior to cell or battery assembly and/or prior to cycling, e.g. in an uncycled cell or battery assembly.

The lithium salt may, in particular embodiments, be lithium bis(trifluoromethanesulfonyl)imide (LIFSI), lithium bis(trifluoromethanesulfonyl)imide (LiTFSI), lithium tetrafluoroborate (LiBF₄), lithium 4,5-dicyano-2-(trifluoromethyl)imidazole (LiTDI), lithium hexafluorophosphate (LiPF₆), lithium iodide (LiI), or any mixtures or combinations thereof, particularly 1-Butyl-3-methylimidazolium bis(trifluoromethanesulfonyl) imide combined with LiTFSI. The lithium salt may further include compounds to enhance electrode stability by impeding the reaction of lithium

In some embodiments, the anode may include pre-lithiated silicon.

### Electrolyte

The electrolyte 100 may be a liquid, gel, or solid electrolyte.

Electrolyte 100 may include an ionic liquid, an organic liquid, or a combination thereof. If the ionic liquid or organic liquid does not supply lithium ion, then electrolyte 100 may include a lithium salt. In more specific embodiments, electrolyte 100 may also include a flame retardant. In some embodiments, the electrolyte may not contain lithium hexafluorophosphate as an electrolyte lithium salt.

Electrolyte 100 may include an ionic liquid, an organic liquid, or a combination thereof. If the ionic liquid or organic liquid does not supply lithium ion, then electrolyte 100 may include a lithium salt. In more specific embodiments, electrolyte 100 may also include a flame retardant.

In some embodiments, the ionic liquid may be any ionic liquid that is a liquid at 20° C. The ionic liquid may be stable (e.g. not degrade to a point where the battery will not function at least 80% of capacity after 10 cycles at 20° C.) up to 70° C. In more specific embodiments, the ionic liquid may include bis(fluorosulfonyl)imide (FSI), bis(trifluoromethane)sulfonamide (TFSI), imidazolium, a phosphonium phosphate, a phosphonium thiophosphate, or any combinations thereof.

If the organic liquid does not supply lithium ion, then electrolyte 100 also includes a lithium salt. In more specific embodiments, electrolyte 100 may also include an additive, such as an additive that reduces or prevents gas creating in cell 10, and additive the reduces or prevents manganese dissolution, or an additive the forms a passivation layer, particularly on the anode, or any combinations of such additives.

In some embodiments, the organic liquid may include:
an ether, such as ethylene glycol dimethyl ether (1,2-dimethoxyethane), ethylene glycol diethyl ether, tetrahydrofuran, 2-methyltetrahydrofuran, 2,6-dimethyltetrahydrofuran, tetrahydropyran, a crown ether, triethylene glycol dimethyl ether, tetraethylene glycol dimethyl ether, 1,4-dioxane, or 1,3-dioxolane;
a carbonic acid ester, such as dimethyl carbonate, methyl ethyl carbonate, diethyl carbonate, diphenyl carbonate, or methyl phenyl carbonate;
a fluorinated ethylene carbonate
a cyclic carbonate ester, such as ethylene carbonate, propylene carbonate, ethylene 2,3-dimethyl carbonate, butylene carbonate, vinylene carbonate, or ethylene 2-vinyl carbonate;
an aliphatic carboxylic acid ester, such as methyl formate, methyl acetate, methyl propionate, ethyl acetate, propyl acetate, butyl acetate, or amyl acetate;
an aromatic carboxylic acid ester, such as methyl benzoate or ethyl benzoate;
a carboxylic acid ester, such as γ-butyrolactone, γ-valerolactone, or 5-valerolactone;
a phosphoric acid ester, such as trimethyl phosphate, ethyl dimethyl phosphate, diethyl methyl phosphate, or triethyl phosphate;
a nitrile, such as acetonitrile, propionitrile, methoxypropionitrile, glutaronitrile, adiponitrile, 2-methylglutaronitrile, valeronitrile, butyronitrile, or isobutyronitrile;
an amide, such as N-methylformamide, N-ethylformamide, N, N-dimethylformamide, N, N-dimethylacetamide, N-methylpyrrolidinone, N-methylpyrrolidone, or N-vinylpyrrolidone;
a sulfur-based compound, such as dimethyl sultone, methyl ethyl sultone, diethyl sultone, sulfolane, 3-methylsulfolane, or 2,4-dimethylsulfolane;
an alcohol, such as ethylene glycol, propylene glycol, ethylene glycol monomethyl ether, or ethylene glycol monoethyl ether;
a sulfoxide, such as dimethyl sulfoxide, methyl ethyl sulfoxide, or diethyl sulfoxide;
an aromatic nitrile, such as benzonitrile or tolunitrile;
a nitromethane;
1,3-dimethyl-2-imidazolidinone;
1,3-dimethyl-3,4,5,6-tetrahydro-2(1,H)-pyrimidinone;
3-methyl-2-oxazolidinone; or any combinations thereof.

In some more specific embodiments, the organic liquid includes a carbonic acid ester, an aliphatic carboxylic acid ester, a carboxylic acid ester, an ether, or any combination thereof.

In some embodiments, the electrolyte may include a flame retardant which may include a perfluorocarbon, an alkane, an ether, a ketone, an amine substituted with one or more alkyl groups, or any combinations thereof. In more specific embodiments, the flame retardant may be at least 60% fluorinated (i.e. 60% of the individual flame retardant molecules are fluoridated).

In some embodiments, the flame retardant includes a ketone having the general formula R′(C═O)R″, wherein R′ is a perfluoroalkyl group and R″ is a perfluoroalkyl group or an alkyl group. More specifically, the ketone is a perfluoroketone, such as dodecafluoro-2-methylpentan-3-one.

In other embodiments, the flame retardant includes an ether having the general formula R′OR″, wherein R′ is a perfluoroalkyl group and R″ is a perfluoroalkyl group or an alkyl group. In more specific embodiments, the ether is a segregated hydrofluoroether, such as methoxy-heptafluoropropane, methoxy-nonafluorobutane, ethoxy-nonafluorobutane, perfluorohexylmethylether, or 2-trifluoromethyl-3-ethoxydodecofluorohexane.

In some embodiments, the flame retardant does not contain ethers or, more specifically, fully or partially halogenated ethers.

In some embodiments, the flame retardant includes an amine substituted with one or more perfluoroalkyl groups, such as perfluorotripentylamine, perfluorotributylamine, perfluorotripropylamine, or perfluoro-n-dibutylmethylamine.

In some embodiments, flame retardant can include a perfluoroalkane such as perfluoropentane, perfluorohexane, perfluoroheptane, perfluoroctane, or perfluoro-1,3-dimethylcyclohexane.

In some embodiments, the flame retardant includes a phosphazene, such as a cyclic phosphazene, more particularly cyclotriphosphazene. In more specific embodiments, the cyclic phosphazene is fully or partially halogenated. In even more specific embodiments, the cyclic phosphazene is fully or partially fluorinated. In still other embodiments, additionally or alternately, the cyclic phosphazene has one or more substituents selected from linear or cyclic alkyl groups, alkoxy groups, cycloalkoxy groups, and aryloxy groups. In more specific embodiments, the substituents are unhaloghenated, fully halogenated or partially halogenated. In other more specific embodiments, the cyclic phosphazene is fully substituted with halogens and substituents such as linear or cyclic alkyl groups, alkoxy groups, cycloalkoxy groups, and aryloxy groups.

In some embodiments, the additive that reduces or prevents gas creation may include vinylene carbonate (VC), Poly(ethyl methacrylate) (PEMA), polyethyl phenylethylmalonamide (PEMAO), Li₂Co₃, and any combinations thereof.

In some embodiments, the additive that forms a passivation layer may include VC, as fluoroethylene carbonate (FEC), polyethylene oxide (PEO), and any combinations thereof.

In some embodiments, the additive reduces or prevents Mn dissolution may include VC, FEC, or any combinations thereof.

In some embodiments, the electrolyte 100 may include another additive, such as an anhydride, prop-1-ene-1,3-sultone (PES), or a combination thereof.

Electrolyte 100 may include any combinations of any or all additives.

In more specific embodiments, the total weight of additives may be about 5 wt % or less of the total electrolyte weight. In still more specific embodiments, the total weight of additive may be between about 1 wt % and about 5 wt %.

In some embodiments, the lithium salt includes LiPF₆, LiFSi, LiTFSI, KFSI, KTFSI, LiBF₄, CH₃COOLi, CH₃SO₃Li, CF₃SO₃Li, CF₃COOLi, Li₂B₁₂F₁₂, LiBC₄O₈;

salts with the general formula R₁—SO₂—NLi—SO₂—R₂, where R₁ and R₂ independently are F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃;

salts with the general formula

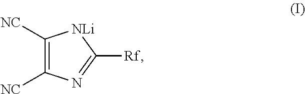

wherein Rf is F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃; or any combinations thereof.

In more specific embodiments, the electrolyte 100 may include between about 0.5 M and about 2 M lithium salt.

In some embodiments, shown in FIG. 1b, cell 10b includes solid electrolyte 100b. Solid electrolyte 100b may include a dried or crosslinked form of the polymer matrix.

In some embodiments, shown in FIG. 1a, cell 10a includes liquid electrolyte 100a in which the organic liquid remains a liquid.

Cell 10a further includes a separator 110. In some embodiments, the separator 110 includes polyethylene, polypropylene, a ceramic material-polymer composite, or any combinations thereof. In more specific embodiments, the separator is a polyethylene-polypropylene-polyethylene tri-layer membrane.

In some embodiments, the separator 110 further includes an electrically insulative material, such as glass. In a specific embodiment, the separator 100 may include glass fibers, particularly glass fibers formed into a porous mat.

In some embodiments, the separator 110 is coated on one or both sides with a ceramic material In more specific embodiments, the ceramic material includes oxides ceramics, sulfide, Al₂O₃, Al₂O₃—SiO₂, lithium aluminum titanium phosphate (LATP), or any combinations thereof.

The voltage of any electrochemical cell according to the present disclosure is the difference between the half-cell potentials at the cathode and the anode, and the cathode active materials and anode active material(s) may be chosen accordingly. The electrolyte may be chosen to avoid or decrease the amount of degradation at the cell voltage.

### Electrode Stacks

The present disclosure relates to electrodes arranged in stacks, such as stacks in which anode/separator/cathode/anode . . . alternate. In some embodiments, the electrode stacks having a slotted structure created by an accordion-shaped separator, which may be referred to as “slot electrodes” or “slot electrode stacks.’ When the separator is folded into an accordion shape, it creates slots on alternating sides of the separator into with cathodes and anodes fit so that there is separator on both sides of each cathode or each anode. A plurality of stopping points, each located at an end of a slot, are also formed by the folds of the separator. These stopping points can help make assembly of the electrode stack easier or prevent electrodes from shifting position too far during use.

In some embodiments, an electrode stack may include alternating layers of cathode/separator/anode. Such a stack might exhibit edge effects, which create areas where electrochemical reactions cannot take place, decreasing the energy density of the cell or battery containing the electrode stack and also possibly resulting in dendrite formation. To avoid this, the ends of the stack may be cut off, for example, with a laser, to achieve more precise boundaries. In some embodiments, scarring resulting from such cutting is performed may be repaired placing metal on the ends of electrode the electrode stack at boundaries after they are cut. In some embodiments, aluminum metal may be placed at one cut edge and copper may be placed at the other cut edge, corresponding to positive and negative ends of the stack.

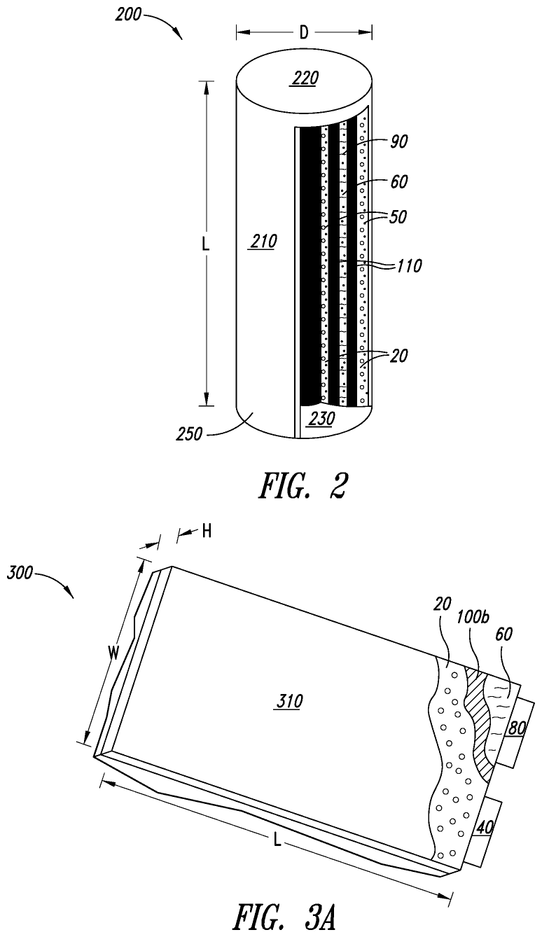

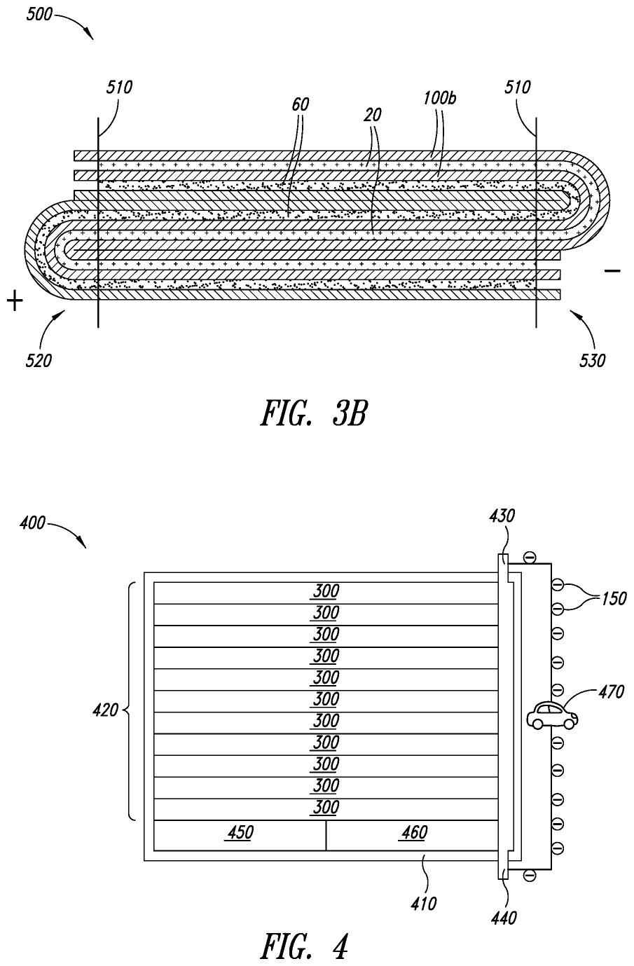

Further electrode stacks are described below with reference to FIG. 3b.

### Batteries

Batteries of the present disclosure include any cathode or electrochemical cell disclosed herein. Batteries of the present disclosure may exhibit any of the electrochemical properties attributed to cathodes, when placed in an electrochemical cell, or electrochemical cells disclosed herein. These properties specifically include discharge energy density, volumetric energy, cycle life, specific discharge capacity, and tap density.

In some embodiments, the battery may be a simple electrochemical cell in a casing. In other embodiments, it may include a more complex electrochemical cell or plurality of cells. For example, in some embodiments, the electrodes may be separated by separators, then rolled within a casing as illustrated in FIG. 2 or stacked within a casing (not shown).

In some embodiments, the casing of a battery may be a polymeric film, a metallic foil, a metal can, or any combination thereof. In some embodiments, the casing may include a vent.

In some embodiments, the battery may be thus formed can be a coin or button cell battery, a cylindrical battery, a prismatic cell battery, or a pouch cell battery.

In some embodiments, a battery as described herein includes active materials that provide a high degree of safety by avoiding or decreasing the chance of fire or thermal runaway. For example, a battery as disclosed herein may continue to operate or not catch fire at higher temperatures. It may also continue to operate at colder temperatures. Furthermore, a battery as disclosed here may exhibit consistent properties (such as consistent capacity and thus consistent battery life between charges) as compared to many currently available commercially available batteries, such as lithium metal oxide batteries or LFP batteries. The batteries described herein may also provide improved energy capacity.

Rechargeable batteries have a range of uses, such as mobile communication devices, such as phones, mobile entertainment devices, portable computers, combinations of these devices that are finding wide use, as well as transportation devices, such as automobiles and forklifts. The batteries described herein that incorporate the positive electrode active materials can possess improvements with respect to specific capacity and cycling, thereby enhancing their performance in consumer materials, especially for medium current applications. Batteries as described herein may, therefore, be used in a variety of commercial forms.

FIG. 2 illustrates a cylindrical battery 200, according to some embodiments of the present disclosure, that operates using the principles of electrochemical cell 10a depicted in FIG. 1a. Battery 200 includes a jelly roll of alternating layers of cathode 20, which has cathode active material 50 on both sides of cathode current collector 40 and anode 60, which also has anode active material 90 on both sides of anode current collector 80. A layer of separator 110 is between each layer of cathode 20 and anode 60. Battery 200 also includes a casing 250 formed from side 210, top 220, and bottom 230. The electrolyte (not shown) is contained by the casing 250.

In some embodiments, the casing 250 has a length L and an average diameter D. In some embodiments, the length L may be between about 2 cm and about 10 cm, about 3 cm and about 10 cm, about 4 cm and about 10 cm, about 4.4 cm and about 10 cm, about 4.45 cm and about 10 cm, about 5 cm and about 10 cm, about 5.05 cm and about 10 cm, about 6.5 cm and about 10 cm, about 2 cm and about 6.5 cm, about 4 cm and about 5.5 cm, or about 4.4 cm and about 5.05 cm, and the diameter D may be between about 1 cm and about 3.5 cm, about 1.05 cm and about 3.5 cm, about 1.45 cm and about 3.5 cm, about 1.5 cm and about 3.5 cm, about 1 cm and about 3 cm, or about 1 cm and about 2 cm, in any combinations of these ranges of lengths and diameters.

In other embodiments, the casing 250 has a length L and an average diameter D. In some embodiments, the length L may be between about 1 cm and about 10 cm, about 5 cm and about 10 cm, about 5 cm and about 8 cm, about 5 cm and about 7 cm, 5 cm and about 20 cm, about 5 cm and about 15 cm, about 5 cm and about 10 cm, 5 cm and about 1 m, about 10 cm and about 1 m, about 20 cm and about 1 m, or about 50 cm and about 1 m, and the diameter D may be between about 1 cm and about 10 cm, about 2 cm and about 6 cm, about 2 cm and about 5 cm, about 2 cm and about 10 cm, or about 5 cm and about 10 cm, in any combinations of these ranges of lengths and diameters.

FIG. 3a illustrates a prismatic cell battery 300, according to some embodiments of the present disclosure, that operates using the principles of electrochemical cell 10b depicted in FIG. 1b. The battery includes a cathode 20, which includes cathode current collector 40, an anode 60, which includes an anode current collector 80, and a solid electrolyte 100 between the cathode 20 and the anode 60. Although FIG. 3a illustrates only one cathode 20 and anode 60 for simplicity, the cathodes and anodes are typically stacked in an alternating fashion with separators between them. The cathodes and anodes also typically contain active material on both sides of the respective current collectors.

Prismatic cell battery 300 further includes a casing 310, which is illustrated as a metal pouch. Prismatic cell battery 300 may have a length, L which may be between about 10 cm and about 1 m, between about 10 cm and about 500 cm, between about 10 cm and between about 100 cm, between about 25 cm and about 1 m, between about 25 cm and about 500 cm, between about 25 cm and about 100 cm, between about 50 cm and about 1 m, between about 50 cm and about 500 cm, between about 50 cm and about 100 cm, between about 100 cm and 1 m, or between about 100 cm and about 500 cm, a width, W, which may be between about 2 cm and about 20 cm, about 2 cm and about 10 cm, about 2 cm and about 5 cm, about 5 cm and about 20 cm, or about 5 cm and about 10 cm, and a height, H, between about 2 cm and about 50 cm, about 2 cm and about 20 cm, about 2 cm and about 10 cm, about 5 cm and about 50 cm, about 5 cm and about 20 cm, about 5 cm and about 10 cm, about 10 cm and about 50 cm, or about 10 cm and about 20 cm, in any combinations of these ranges of lengths, width, and heights.

Prismatic cell battery 300 may, in an embodiment not illustrated in FIG. 3a, contain an electrode stack 500, made up of electrodes and solid electrolyte, as illustrated in FIG. 3b. Electrode stack 500 is formed by folding the electrodes 20 and 60 and solid electrolyte 100 sandwiched between them back and forth on top of themselves, as depicted. Electrode stack 500 would typically exhibit edge effects at ends 520 and 530, where the folds are located. Edge effects result when dead areas through which lithium ions cannot move and accumulate on some portions of the cathode or anode. These areas do not participate in electrochemical reactions and, thereby, decrease the energy density of the cell or battery. Dead areas are sometimes formed from plated lithium metal in the form of dendrites, which can cause the cell or battery to short circuit, particularly in embodiments with a liquid electrolyte, another edge effect. Accordingly, to avoid edge effects, ends 520 and 530 are typically cut off the electrode stack 500, for example at boundaries 510. Often a laser is used to make the cut to achieve precise boundaries 510. However, even when a laser is used, the electrodes 20 and 60 and solid electrolyte 100 (or a separator, if present) in electrode stack 500 are often scarred at the cut edges. Scarring may be repaired by placing metal on the ends of electrode stack 500 at boundaries 510 after they are cut. In some embodiments, aluminum metal may be placed at the cut edge formed by cutting and removal of end 520, which corresponds to the positive end of electrode stack 500, and copper metal may be placed at the cut edge formed by cutting and removal of end 530, which corresponds to the negative end of electrode stack 500.

Similar placements of metals at cut edges of electrodes or electrode stacks may be used with other configurations.

FIG. 4 illustrates a battery module or pack 400, such an electric vehicle battery, which includes a battery stack 420 of prismatic cell batteries 300, such as those illustrated in FIG. 3a or similar to those of FIG. 3a, but with an electrode stack 500 as shown in FIG. 3b. Other battery packs may be formed in the same manner. Battery stack 420 is enclosed in a housing 410. Anode current collectors 80 and cathode current collectors 40 in each of batteries 300 are electrically connected to negative connector 430 and positive connector 440, respectively. Electrons 150 may flow between negative connector 430 and positive connector 440 to power vehicle 470, or (not shown), when connected to an energy source, such as a DC power supply, to charge battery 400.

The battery 400 may also include safety equipment 450, control equipment 460, or both. Safety equipment 450 and control equipment 460 may located inside housing 410, or all or part of safety equipment 450 or control equipment 460 may be located outside housing 410. In some embodiments safety equipment 450 may include equipment that minimizes damage should one of batteries 300 fail or potentially or actually cause damage. For example, safety equipment 450 may include a fan or a fire-suppression material and delivery system. In some embodiments control equipment 460 may include a processor and an associated memory, in which the processor is able to execute a program stored in the associated memory to control one or more functions of the battery 400. The processor may also receive information regarding battery 400, vehicle 470, or batteries 300 and use such information to control one or more functions of battery 400.

If the prismatic cells 300 in FIG. 4 are large format batteries, then the overall energy density and weight-dependent properties of battery 400 may be improved because additional negative connector 430 and positive connector 440 material may not be needed as compared to batteries with smaller prismatic cells. Similarly, additional safety equipment 450 or control equipment 460 may not be needed as compared to batteries with smaller prismatic cells. In some embodiments, additional negative connector 430 or positive connector 440 material, safety equipment 450, or control equipment 460 may be needed, but may not exhibit an increase in weight proportional to the increase in battery 300 weight as compared to batteries with smaller prismatic cells.

A battery similar to that of FIG. 4 may also be used in a grid storage device, to power a ship, or in other applications where a large format battery are useful.

### Methods of Making Electrodes, Cells, and Batteries

Cathode layer 30 may be applied to cathode current collector 40 using liquid coating or dry coating with extrusion methods.

In some embodiments, a paste or slurry containing the cathode active material 50, with any coating or dopant present on or in the active material, and any conductivity enhancers or binders is applied to one or both sides of the cathode current collector 40 then dried. In some cathode coating methods PVDF binder is dissolved in a N-methylpyrrolidone (NMP) solvent. In other cathode coating methods, synthetic rubber binder is dissolved in water.

In some more specific embodiments, the electrode is pressed using calendaring rolls, a press with a die, or other suitable pressure equipment to compress the electrode to a set thickness. In even more specific embodiments, the electrode is pressed at a pressure between about 70 mPA and about 90 mPA. In other more specific embodiments, the electrode is pressed at a pressure between about 20 kg/cm² and 100 kg/cm².

Once pressed, if a pressing is used, the electrode may then be dried, for example in an oven, to remove all or part of any solvent used to form the paste or slurry.

Anodes may be prepared in a similar fashion.

In some embodiments, particularly where a binder, dopant, or coating is not present, cathode active materials 50 may be deposited on the current collector 40 by chemical vapor deposition.

### EXAMPLES

The following examples are provide to facilitate an understanding of the embodiments described herein. Elements of the examples may be absent from some embodiments, and elements of the examples may be combined individually with other aspects of embodiments as disclosed herein throughout this specification, not merely within a given example. No example is intended to encompass the entirety of the inventions.

### Example 1: Capacity Fade Under Use Conditions

A specific testing procedure that can be used to evaluate the performance of the cells batteries disclosed herein involves cycling the cell or battery between 4.6 volts and 2.0 volts at 20° C. Evaluation over the range from 4.6 volts to 2.0 volts is particularly relevant to actual use conditions because cells and batteries as described herein typically exhibit stable cycling over this voltage range.

For the first three cycles, the cell or battery is discharged at a rate of C/10 to establish irreversible capacity loss. The cell or battery is then cycled for three cycles at C/5. For cycle 7 and beyond, the cell or battery is cycled at a rate of C/3, which is a reasonable testing rate for medium current applications.

The cell or battery capacity generally depends significantly on the discharge rate, with loss of capacity as the discharge rate increases.

Cells of batteries according to the present disclosure are expected to exhibit a specific discharge capacity during the tenth cycle at a discharge rate of C/3 of 200 mAH/g or more, or 210 mAh/g or more.

Furthermore, at the 20^{th} cycle, discharge capacity of the cell or battery is expected to be about 99% or more of that at the tenth cycle at a discharge rate of C/3.

Some cells or batteries may even, at the 20^{th} cycle, have a discharge capacity that is about 99% or more of that 5^{th} cycle discharge capacity at a discharge rate of C/3.

It should be understood that the terms “a” and “an” as used herein refer to “one or more” of the enumerated components. The use of the alternative (e.g., “or”) should be understood to mean either one, both, or any combination thereof of the alternatives. As used herein, the terms “include,” “have,” and “comprise” are used synonymously, which terms and variants thereof are intended to be construed as non-limiting.

The various embodiments described above can be combined to provide further embodiments. Aspects of the embodiments can be modified in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An uncycled lithium ion cathode comprising:
i) a lithium manganese iron phosphate (LMFP) cathode active material, a lithium manganese nickel iron phosphate (LMNFP) cathode active material, a lithium iron phosphate (LFP) cathode active material, a lithium iron cobalt phosphate (LFCP) cathode active material, a lithium iron manganese cobalt phosphate (LFMCP) cathode active material, or any combinations thereof; and
ii) a manganese iron phosphate (MFP) cathode active material, a manganese nickel iron phosphate (MNFP) cathode active material, an iron phosphate (FP) cathode active material, an iron cobalt phosphate (FCP) cathode active material, an iron manganese cobalt phosphate (FMCP) cathode active material, or any combinations thereof,
wherein:
the LMFP cathode active material has the general chemical formula LiMnₓFe₁₋ₓPO₄, wherein 0.01≤x≤0.95;
the MFP cathode active material has the general chemical formula MnₓFe₁₋ₓPO₄, wherein 0.01≤x≤0.95;
the LMNFP cathode active material has the general chemical formula LiMnₓNi_{y}Fe_{1-(x+y)}PO₄, wherein 0<x<1, 0<y<1 and x+y<1 and wherein the ratio of x:y is in a range between 5:1 and 1:5;
the MNFP cathode active material has the general chemical formula MnₓNi_{y}Fe_{1-(x+y)}PO₄, wherein 0<x<1, 0<y<1 and x+y<1, and wherein the ratio of x:y is in a range between 5:1 and 1:5;
the LFCP cathode active material has the general chemical formula LiFe₁₋ₓCoₓPO₄, in which 0<x<1;
the FCP cathode active material has the general chemical formula Fe₁₋ₓCoₓPO₄, in which 0<x<1;
the LFMCP cathode active material has the general chemical formula LiFe_{1-(x+y)}MnₓCo_{y}PO₄, wherein 0<x<1, 0<y<1 and x+y<1 and wherein wherein the ratio of x:y is in a range between 5:1 and 1:5; and
the FMCP cathode active material has the general chemical formula Fe_{1-(x+y)}MnₓCo_{y}PO₄, wherein 0<x<1, 0<y<1 and x+y<1 and wherein the ratio of x:y is in a range between 5:1 and 1:5; and
wherein at least one of the LMFP, LMNFP, LFCP, LFMCP, LFP, MFP, MNFP, FCP, FMCP, or LP is coated with conductive carbon.

2. The uncycled lithium ion cathode of claim 1, comprising:
i) a LMFP cathode active material; and
ii) a MFP cathode active material, a MNFP cathode active material, an FP cathode active material, an FCP cathode active material, an FMCP cathode active material, or any combinations thereof.

3. The uncycled lithium ion cathode of claim 1, comprising:
i) a LMNFP cathode active material; and
ii) a MFP cathode active material, a MNFP cathode active material, an FP cathode active material, an FCP cathode active material, an FMCP cathode active material, or any combinations thereof.

4. The uncycled lithium ion cathode of claim 1, comprising:
i) a LFP cathode active material; and
ii) a MFP cathode active material, a MNFP cathode active material, an FP cathode active material, an FCP cathode active material, an FMCP cathode active material, or any combinations thereof.

5. The uncycled lithium ion cathode of claim 1, comprising:
i) a LFCP cathode active material; and
ii) a MFP cathode active material, a MNFP cathode active material, an FP cathode active material, an FCP cathode active material, an FMCP cathode active material, or any combinations thereof.

6. The uncycled lithium ion cathode of claim 1, comprising:
i) a LFMCP cathode active material; and
ii) a MFP cathode active material, a MNFP cathode active material, an FP cathode active material, an FCP cathode active material, an FMCP cathode active material, or any combinations thereof.

7-23. (canceled)

24. The uncycled lithium ion cathode of claim 1, wherein the relative amounts of i) LMFP cathode active material, LMNFP cathode active material, LFP cathode active material, LFCP cathode active material, LFMCP cathode active material, or any combinations thereof; and ii) MFP cathode active material, MNFP cathode active material, FP cathode active material, FCP cathode active material, FMCP cathode active material, or any combinations thereof, are such that-when the cathode is cycled in an electrochemical cell, the cell at its tenth cycle has a specific energy within 10% of the maximum theoretical specific energy of the cell.

25-26. (canceled)

27. The uncycled lithium ion cathode of claim 1, wherein, when the cathode is cycled in an electrochemical cell, the cell at its tenth cycle has a specific capacity that is about 100 mAh/g or more when measured at 23° C. when discharged from 4.2 V.

28. A lithium ion cell comprising:
an uncycled lithium ion cathode of claim 1;
an anode comprising an anode active material; and
an electrolyte.

29. The lithium ion cell of claim 28, wherein the anode active material comprises a graphite, natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, hard carbon, or hard carbon and amorphous silicon or silicon nanotubes, or any combinations thereof.

30. The lithium ion cell of claim 28, wherein the anode comprises a first anode active material and a second anode active material, both individually comprising a material selected from: a graphite, natural graphite, synthetic graphite, hard carbon, mesophase carbon, appropriate carbon blacks, coke, fullerenes, lithium metal, lithium powder, niobium titanium oxide (TNO) niobium pentoxide, intermetallic alloy, silicon alloy, tin alloy, silicon, silicon oxide, titanium oxide, tin oxide, lithium titanium oxide, silicon-functionalized graphene, silicon-functionalized graphite, other silicon-functionalized carbon, amorphous silicon, silicon nanotube, silicon compound, SiOₓ, in which x≤2 or x<2, graphene, carbon nanotube, hard carbon, or hard carbon and amorphous silicon or silicon nanotubes, or any combinations thereof.

31. The lithium ion cell of claim 28, wherein the anode is uncycled and does not contain lithium.

32. The lithium ion cell of claim 28, wherein the anode comprises a lithium reservoir.

33. The lithium ion cell of claim 28, wherein the electrolyte comprises an organic liquid and a lithium salt.

34. The lithium ion cell of claim 28, wherein the electrolyte is a liquid or gel and the cell further comprises a separator between the cathode and the anode, wherein the separator is coated on one or both sides with a ceramic material.

35-36. (canceled)

37. The lithium ion cell of claim 28, where an added source of lithium is provided in the cell that is not contained within the cathode.

38. The lithium ion cell of claim 28, wherein:
when the cell is cycled:
the cell has a discharge energy density of 200 Wh/kg or more when discharged from 4.2V to 2.5V at C/3 that varies by 10% or less during discharge at a temperature in the range between about −40° C. and about 85° C.;
the cell has a volumetric discharge energy density of 500 Wh/L or more when discharged from 4.2V to 2.5V at C/3 that varies by 10% or less during discharge at a temperature in the range between about −40° C. and about 85° C.; and/or
the cathode active material has a resulting tap density of about 1.2 g/cm³ or more; and/or
the cell has a cycle life of about 1000 cycles or more.

39-43. (canceled)

44. A battery comprising:
at least one lithium ion cell of claim 28; and
a casing.

45-47. (canceled)

48. A battery pack comprising:
at least one battery according to claim 44;
a positive connector;
a negative connector; and
a housing.

49. (canceled)

50. A method of forming an electrode stack in a battery according to claim 44, the method comprising:
folding a cathode and an anode with a separator between them back and forth to form an electrode stack with a first end at which folds are located;
cutting the electrode stack with a laser to remove both ends at which folds are located and to form a first cut edge and a second cut edge;
placing aluminum metal at the first cut edge; and
placing copper metal at the second cut edge.
